(19) United States
(12) Patent Application Publication
(10) Pub. No.: US 2025/0064006 A1
(43) Pub. Date: Feb. 27, 2025

(54) SOILLESS GROWING SYSTEM AND METHOD

(71) Applicant: PLAIN GREENS LTD, Whitchurch (GB)

(72) Inventor: MIchael Sean CROSSLAND, Huntington, Chester (GB)

(21) Appl. No.: 18/724,972

(22) PCT Filed: Dec. 29, 2022
(86) PCT No.: PCT/GB22/53399

§ 371 Date: Jun. 27, 2024

(30) Foreign Application Priority Data
Dec. 31, 2021 (GB) 2119146.5

(51) Int. Cl. A01G 31/06; A01G 31/00

(52) U.S. Cl. CPC A01G 31/06; A01G 2031/006

(57) ABSTRACT

The soilless growing system includes one or more grow modules. Each grow module includes an enclosable volume having an interior configured to receive at least one plant in a removable plant holder in a removable grow bed. The grow bed and plant holder permit growth of the plant therethrough. There is artificial lighting to provide light energy to the plant and a nutrient module to supply and condition an aqueous nutrient solution to the grow module. An HVAC module supplies and conditions a gaseous environment to the grow module, the HVAC module supplying carbon dioxide into the interior of the grow module.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

This invention relates to a soilless growing system and its method of use. In particular, this invention relates to a modular soilless growing system that integrates various farming processes and which provides the optimum conditions for crop growth in a closed aeroponics system that reduces external contamination, and mitigates carbon dioxide (CO2) enrichment safety issues. The soilless growing system being modular in nature which provides for inherent economies of scale, improves waste heat recovery and crop densities, and is variably automatable depending upon the resources available.

### 2. Description of Related Art Including Information Disclosed Under 37 CFR 1.97 and 37 CFR 1.98

Agriculture and farming is the basis of subsistence for the population by providing sustenance, nutrition and stability. Historically, it was the key driver for civilizations to cease hunter-gatherer practices in favor of permanent settlements that could provide for much larger populations.

It is known that agricultural workers often work long hours because of the lengthy processes involved in the day-to-day management of crops and livestock. It has been recognized that severe weather and poor soil conditions, which are often brought about by climate change, along with a gradual reduction in agricultural lands, means that traditional farming in fields is not always the best solution to feed the growing population. In addition, pests can damage or consume the crop, and significant resources (in terms of both labor and machinery) are needed to harvest the crop. The effects of climate change, and the competition for resources and space, have meant that farmers have the unenviable task of producing more food with less. It is widely-accepted that by 2050, there will be a need to at least double our agricultural output to keep up with the world's food demands.

With this in mind, it has been known for a number of years that alternatives to conventional growing methods are required; and various soilless growing techniques have been proposed to grow crops indoors and in three dimensions. It is known that plants do not need soil in order to grow. Conventional planting methods use soil as a substrate to grow in, as it typically contains the nutrients and water they require to grow. A secondary function of the soil is to provide support, i.e., to allow the plant a physical point to anchor to. Soilless growing techniques however not only reduces the number of inputs, but makes the growing system much easier to observe, monitor and ultimately control.

Within the past few decades, techniques such as hydroponics, aquaponics and aeroponics have become increasingly popular as expansive plots of land are not generally required. In a hydroponic system, plants are grown with the roots either continuously or periodically submerged in water-based, nutrient-rich solutions. Aquaponics is a subset of hydroponics whereby the nutrient-rich solution is generated by fish, instead of directly adding nutrients to the water (as in hydroponics). Fish are grown within the water, producing an ecosystem where the fish excrement feeds the crops.

With aeroponics, crops are suspended in a grow bed above an empty chamber. The roots are periodically sprayed with an atomized nutrient solution. Methods for atomizing the nutrient solution vary from pressurized misters to acoustic vaporization. Run-off can be recaptured and re-used. Whilst aeroponics systems are technically the most complicated of the soilless growing methods due to atomization requirements, they have the smallest overall mass, and the highest oxygenation rate of roots. This, in theory, produces the fastest-growing and most efficient technique. Water uptake is completely controllable, and it is the one solution that shows the most commercial promise.

Various modular soilless growing systems have been developed over recent years. Fully-contained or enclosed growing spaces are known in the prior art. WO2020/030825 A1 describes a growing system that is directed towards hydroponic vertical farming in which growing trays containing plants are conveyed from one end of a growing space to the other, and that stacks of such conveyable trays can be placed in one growing space, which can be a room, warehouse, factory or the like.

WO2020/028381 A1 describes what appears to be an aeroponics system that is based around an ISO container-sized “farm”, but one which needs significant user intervention as it describes the operator spending many hours a week working on farm operations.

Neither of the two patent publications describe crops being grown in discrete enclosures that ensure automatic and controllable conditions and nutrient supplies, without the need for manual replanting activities, nor the provision of safe CO2 enrichment. WO2020/030825 A1 describes that the tray containing the crop traverses slowly from a starting end to an opposite harvesting end. WO2020/028381 A1 also describes one enclosure for the crops, but it is not automated, and the crops are exposed to the same environment as the operator.

Though great strides have been made with known soilless farming systems mentioned above, they still require substantial operator involvement, care and specialized conditions. What is needed is a soilless growing system that can allow for a self-sustaining, modular farming system. Accordingly, there is the need for a modular soilless growing system that can integrate various farming processes through interconnected modules, and which allows the growing of multiple crops within the same system. There is also the need for a soilless growing system and its method of use that provides the optimum conditions for crop growth in a closed aeroponics system that reduces external contamination, and mitigates CO2 enrichment safety issues.

It is an object of the present invention to provide a soilless growing system and its method of use which overcomes or reduces the drawbacks associated with known products of this type. It is a further object of the present invention to provide a soilless growing system being modular in nature which provides inherent economies of scale, improves waste heat recovery and crop densities, and is variably automatable depending upon the resources available.

### BRIEF SUMMARY OF THE INVENTION

The present invention is described herein and in the claims.

According to the present invention there is provided a soilless growing system comprising one or more grow modules, each grow module comprising:
an enclosable volume having an interior configured to receive at least one plant in a removable crop holder within a removable grow bed, the grow bed and crop holder configured to permit growth of the plant therethrough; and
artificial lighting configured to provide light energy to the plant,
a nutrient module configured to supply and condition an aqueous nutrient solution to the grow module; and
a HVAC module configured to supply and condition a gaseous environment to the grow module, the HVAC module configured to supply carbon dioxide into the interior of the grow module.

An advantage of the present invention is that the soilless growing system ensures automatic and controllable conditions and nutrient supplies, and provides CO2 enrichment in a safe manner to optimize plant growth conditions.

Preferably, wherein the grow module is air-tight and optically opaque.

Further preferably, the grow module is formed as an elongated square bifrustum, triangular bipyramid, cuboid, rectangular cuboid, pentagonal bipyramid, hexagonal bipyramid or any suitable polyhedral shape.

In use, the grow module may be divided into an upper volume above the grow bed which permits growth of the plant, the upper volume having an optically reflective internal surface, and a lower volume beneath the grow bed into which the roots of the plant are periodically sprayed with the aqueous nutrient solution, the lower volume comprising a sealing liner attached to the side walls thereof, wherein the sealing liner collects and returns excess aqueous nutrient solution to the nutrient module via an outflow.

Preferably, a section of the upper volume of the grow module immediately above the grow bed and which extends perpendicular to the plane of the grow bed in a vertical direction allows the grow bed to be removable by lifting it in a generally vertical direction first before moving it in a lateral plane.

Further preferably, the vertical height of the grow module is at least the same, or higher, than the width of the grow module in order to accommodate and permit unobstructed growth of the plant above the grow bed and the roots below the grow bed.

In use, the grow module may comprise a door assembly configured to provide access to the upper volume thereof, the grow module and door assembly being covered by a thermally-insulating layer.

Preferably, the grow module comprises one or more sensors disposed therein for monitoring the grow module and/or plant growth, the one or more sensors selected from the group consisting, but not limited to, any one of the following: temperature sensor, humidity sensor, pressure sensor, carbon dioxide sensor, digital image capture, light sensor, airflow sensor, and combinations thereof, the output of the sensors being sent to a processing means configured to monitor and control plant growth by controlling the artificial lighting, the nutrient module and the HVAC module.

Further preferably, the grow bed is situated upon a weigh frame and one or more load sensors disposed in the lower volume thereof, the one or more load sensors being configured to monitor the mass of the grow bed, the output of the one or more load sensors being sent to the processing means.

In use, the roots of the plant may be periodically sprayed with the aqueous nutrient solution via one or more impingement nozzles disposed in the lower volume of the grow module, the impingement nozzles being configured to provide a wide-angled spray pattern.

Preferably, the system comprising an upper air circulation interface being situated above the grow bed, and an opposite lower air circulation interface being situated below the grow bed, the air circulation interfaces conveying the gaseous environment to the grow module and enabling circulation beneath the plant canopy and enable extraction and/or supply of airflow beneath the canopy via a perforated grow bed.

Further preferably, the perforated grow bed being configured to allow airflow through the grow bed using channels disposed within the grow bed in fluid communication with conduits attached to the side walls of the lower volume to extract or supply air from, or to, the grow bed via the lower air circulation interface.

In use, the system may comprise one or more plant holders positioned in, and extending completely through, the grow bed, the plant holders configured to hold plants, wherein the roots of supported plants are exposed to the aqueous nutrient solution.

Preferably, the plant holder being constructed of one or more pieces which, when combined, create an overall annular shape, with an outer shoulder for locating the component pieces, having a centrally-disposed opening that extends from the upper surface of the holder to a central cavity within the holder; the cavity comprising an concaved lower face, promoting liquid pooling, with a centrally-disposed concaved recess, to locate and prevent seeds from escaping from one or more radially-disposed openings that extend through the lower surface of the inner cavity, and that permit the ingress of fluid.

Further preferably, the plant holder being constructed of a flexible unabsorbant material that exerts a compressive force, providing a point of anchoring, on the plant stem that protrudes through the upper centrally-disposed opening and allows the plant's roots to part the lower face of the inner cavity via the one or more radially disposed-openings.

In use, the assembled plant holder may be receivable in an annular carrier which seats inside a receiving aperture disposed in the grow bed, the carrier having engagement means for ease of transport and/or having a perforated elongate structure for supporting the growing plant.

Alternatively preferably, the plant holder being annular in shape having a centrally-disposed opening that extends completely therethrough, the opening being generally square-shaped in cross section from above for receiving a foam substrate configured to provide structure for plants to root into, plants rooted in the foam substrate having roots that grow downwards and extend into the lower volume of the grow module, the centrally-disposed opening having a sloped inner edge to prevent the substrate from falling through the opening when in use, the plant holder having a collar which seats inside receiving apertures disposed in the grow bed.

Further preferably, the foam substrate comprises a cuboid-shaped body portion having a concaved top surface and a slit running through the vertical height thereof, the concaved shape supports one or more seeds and a nutrient mixture droplet thereon, such that when the seed germinates a second foam lid is situated on top of the body portion to cover the nutrient droplet from incident light.

In use, the nutrient module may comprise:
a nutrient reservoir in which the conductivity and pH are monitored;
fresh water, nutrients and pH regulators and combinations thereof being supplied to the nutrient reservoir using dosing pumps; and
a diaphragm pump configured to pressurise an intermediary storage vessel which enables the pump to operate intermittently or periodically, such that the aqueous nutrient solution is supplied which is nutrient-rich and contributes to the growth of plants in the soilless growing system.

Preferably, the diaphragm pump regulates the pressure between around 4 bar to around 6 bar.

Further preferably, excess aqueous nutrient solution is returned via the outflow in the grow module and/or condensate run-off from the HVAC module is returned to the nutrient reservoir under gravity, this returned solution being passed through a filter trap before entering into the nutrient reservoir.

In use, the HVAC module may be operative to supply a treated gaseous environment to the grow module, wherein the treatment is selected from the group consisting, but not limited to, any one of the following: filtration, ventilation, heating, cooling, humidification, pressurisation, carbon dioxide concentration, and combinations thereof.

Preferably, the HVAC module comprises:
a fan for inducing air flow between an inlet and outlet header, an outdoor air valve/damper for controlling an inflow flow rate of fresh air introduced into a supply air duct, an exhaust valve/damper installed on an exhaust duct for discharging air from the grow module, a circulating air valve/damper installed to control the flow rate through a conditioning bypass line;
a carbon dioxide supplying device for adding carbon dioxide to the air circulated through the grow module(s);
a humidifying device for humidifying the air circulated through the grow module(s); and
a hot/cold water heat exchanger for heating or cooling the air circulated through the grow module(s).

Further preferably, each nutrient module and HVAC module is each connectable to a plurality of grow modules.

In use, the modules may be supported in a modular racking which comprises a generally horizontal spanning member, the ends of the horizontal spanning member being receivable between pairs of vertical frame members which include a module support arm configured to support a mounting point disposed on the grow module, the modular racking being longitudinally extendable into aisles and configured to stackably support one or more other assembled racking layers above and/or below itself within the system.

Preferably, wherein the assembled racking is placed on wheeled trolleys enabling movement thereof.

Further preferably, the system further comprising one or more elevating devices to automatically move the grow bed between horizontally and/or vertically-spaced modules and/or to and from a processing area.

In use, the system may further comprise an automated soilless growing optimizer comprising one or more computer processors having instructions written in software, wherein the instructions, when executed by the one or more processors, cause the processor to perform operations comprising:
performing a plurality of experiments for growing a plant, each experiment controlled by a recipe from a plurality of recipes that identifies parameters for growing plants;
obtaining a machine learning model by training a machine learning algorithm using the experimental results; and
creating, by the machine learning model, a new optimized recipe for growing a plant.

Preferably, the system comprising an automated load-scheduling system which comprises one or more computer processors having instructions written in software, wherein the instructions, when executed by the one or more processors, cause the processor to perform operations comprising:
delay, bring-forward, shorten and/or extend scheduled automated activities of the system sub modules/units including but not limited to; photoperiods, cleaning operations, pressurization and/or aisle movements; and
optimize the economy/efficiency of any such actions to assess the detriment to the crops and advantage of meeting a configurable/settable load/power-demand profile based upon historic data; and
thereby creating an optimized strategy for operation of the soilless growing system.

Further according to the present invention there is provided a method of growing plants in a soilless growing system, the method comprising the steps of: seeding a grow bed; germinating the seeds; growing the plants; and harvesting the plants, the plants being seeded, germinated, grown and harvested on the same grow bed within a soilless growing system as hereinbefore described.

It is believed that a soilless growing system and its method of use in accordance with the present invention at least addresses the problems outlined above.

It will be obvious to those skilled in the art that variations of the present invention are possible and it is intended that the present invention may be used other than as specifically described herein.

### BRIEF DESCRIPTION OF THE SEVERAL VIEWS OF THE DRAWINGS

The present invention will now be described by way of example only, and with reference to the accompanying drawings.

FIG. 1 is a perspective view from the side and above of a modular soilless plant growing system in accordance with the present invention.

FIG. 2 shows a high-level schematic view of a diagram of a modular soilless growing system in accordance with the present invention and showing the inputs and outputs thereto.

FIG. 3 is a high-level schematic view of a diagram of a primary grow module according to an embodiment of the present invention.

FIGS. 4 and 5 show front cutaway sectional views of a primary grow module according to an embodiment of the present invention.

FIG. 6 illustrates a front perspective view of a primary grow module according to an embodiment of the present invention and showing the insulation, access door and grow bed omitted for clarity purposes.

FIG. 7 is a perspective view from the rear and above showing how a primary grow module is connectable to a neighboring primary grow module according to an embodiment of the present invention.

FIG. 8 is a high-level side cross-sectional view of a primary grow module according to an embodiment of the present invention.

FIG. 9 is a high-level side cross-sectional view of a grow bed according to an embodiment of the present invention.

FIGS. 10a and 10b are side and top plan views, respectively, of a crop holder according to an embodiment of the present invention that is receivable in the grow bed.

FIGS. 11a, 11b and 11c are side cross-sectional views of the crop holder of FIG. 10 at various stages of seedling growth.

FIG. 12 shows a perspective view from the side and above of the crop holder of FIG. 10 with a plant supported on a foam substrate.

FIG. 13a is a perspective view from the side and above of one half of an alternative crop holder according to an embodiment of the present invention.

FIG. 13b showing a perspective view of the alternative crop holder assembled from the two identical abutting halves.

FIG. 14 is a schematic view as a photographic image obtained from a camera disposed in the top of the primary grow module and being directed downwards towards the grow bed.

FIG. 15 is a high-level schematic view of a diagram of a nutrient control module according to an embodiment of the present invention.

FIG. 16 is a perspective view from the side and above showing the components of the nutrient control module of FIG. 15 in further detail.

FIG. 17 is a high-level schematic view of a diagram of a heating, ventilation and air conditioning (HVAC) module according to an embodiment of the present invention.

FIG. 18 is a perspective view from the side and above showing the components of the HVAC module of FIG. 17 in further detail.

FIG. 19 illustrates a side cutaway view of an alternative way of removing heat from the light source in the primary grow module.

FIG. 20 shows a perspective view from the side and above of racking onto which the individual modules of the present invention are mountable.

FIG. 21 is a perspective view from the side and above showing how the racking of FIG. 20 can be mounted on trolleys to permit movement thereof.

FIG. 22a shows a plan view from above which illustrates how the racking can be configured to provide static access aisles; and FIGS. 22b and 22c illustrate how the racking of FIG. 21 can be configured to provide moveable aisle access and thereby maximizing crop yield per unit area.

FIG. 23 is a high-level schematic view of a diagram of a harvester according to an embodiment of the present invention.

FIGS. 24a and 24b illustrate schematic views of how the harvester can be used in conjunction with the racking of FIG. 21 to access an individual primary grow module.

FIG. 25 outlines a schematic view of how crops are grown and harvested using the modules described herein.

FIG. 26 is a schematic view of a high-level illustration of how machine learning can be utilized to optimize crop yield.

FIGS. 27a and 27b show graph illustrations of two different options for load scheduling to enable the modular soilless growing system to access cheaper electricity tariffs, with FIG. 27a showing that the photoperiod can be moved between allowable limits, and FIG. 27b showing that the photoperiod can be split throughout the day.

FIG. 28 is a graph illustration showing that such load scheduling shown in FIGS. 27a and 27b has an effect on the load, or requested deviations from the nominal load by the electricity supplier.

FIG. 29a is a perspective view from the side and above of one half of an alternative substrate-less crop holder.

FIG. 29b shows a front view of the alternative crop holder assembled from the two identical abutting halves and shown being very slightly spaced-apart for reasons of clarity.

FIG. 30 shows a perspective view of the assembled alternative crop holder of FIG. 29b being retained in a carrier ring.

FIG. 31 shows a perspective view of an alternative carrier ring which is extended in a vertical dimension to provide a mechanical interface point for supporting the growing crop.

### DETAILED DESCRIPTION OF THE INVENTION

The present invention has adopted the approach of providing a soilless growing system and its method of use which overcomes or reduces the drawbacks associated with known products of this type. Advantageously, the present invention provides a soilless growing system that is modular in nature enabling inherent economies of scale, improves waste heat recovery and crop densities, and is variably automatable depending upon the resources available.

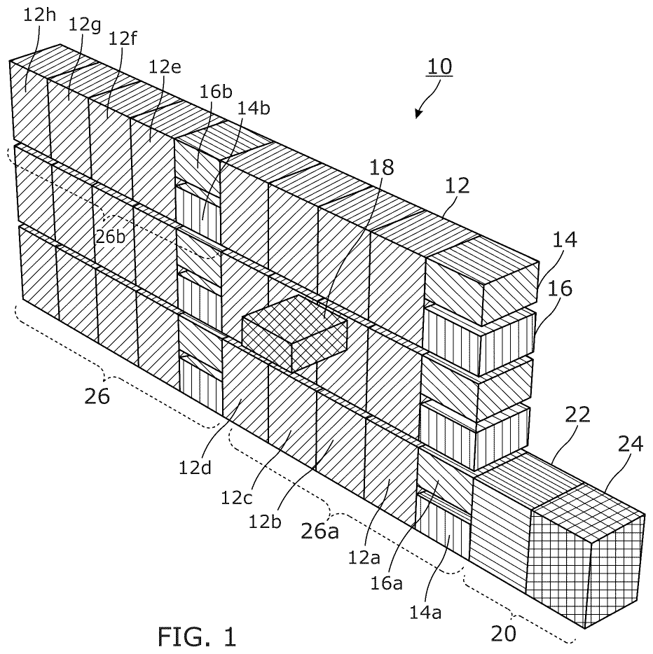

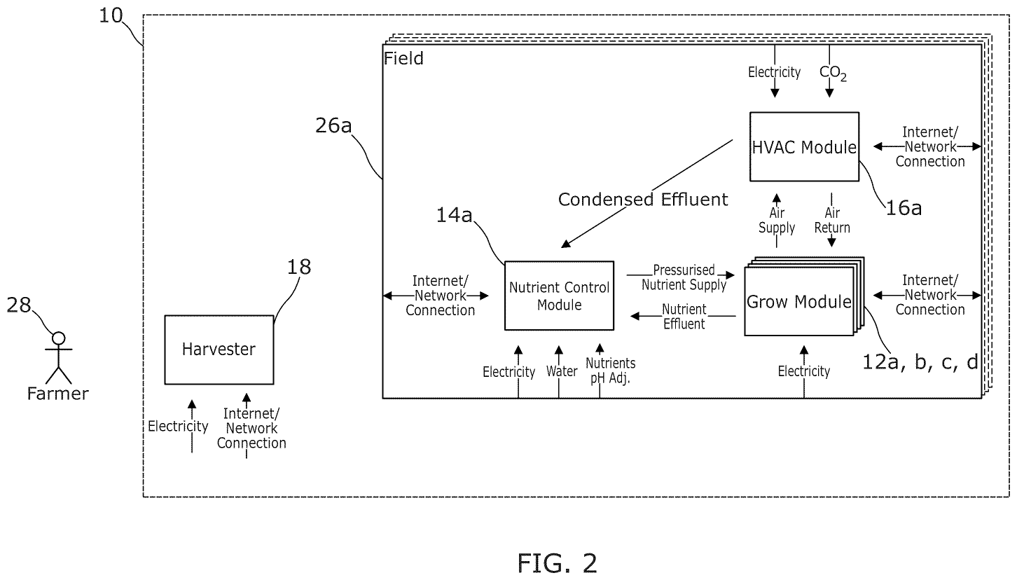

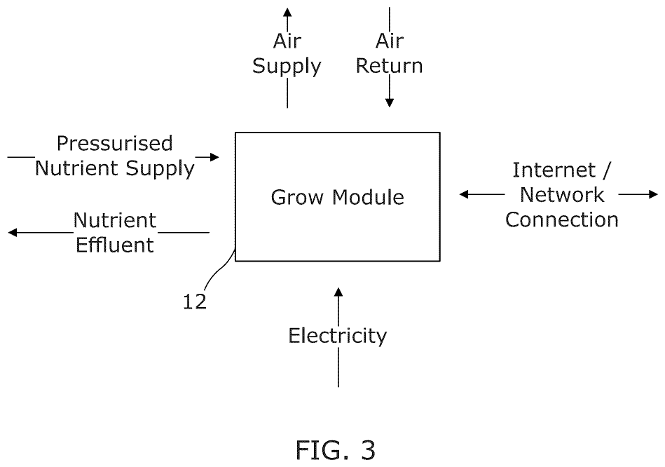

Referring now to the drawings, a modular soilless growing system 10 according to the present invention is illustrated in FIGS. 1 and 2. Specifically, the modular soilless growing system 10 comprises an automatable crop production system or platform that is intended to grow a wide variety of crops from seed to “serving”. At its core, the system 10 comprises a number of discrete or individual modules, each performing different functions, that can be operated together to provide a highly-flexible soilless growing platform. The modular soilless growing system 10 comprises a number of primary grow modules 12 which consist of an enclosed volume within which seeds 102 can germinate and grow into crops 32. Further detail of the primary grow module 12 is set out in FIGS. 3 to 14 below.

As illustrated in FIGS. 1 and 2, a nutrient control module 14 and a heating, ventilation and air conditioning (HVAC) module 16 each supply a number of grow modules 12. In one embodiment of the invention, each nutrient control module 14a and HVAC module 16a is each connectable to four grow modules 12a, 12b, 12c, 12d, although the skilled person will understand that this is in no way intended to be limiting as, in use, the present invention, being modular in nature, can be configured having any ratio of grow modules 12 to nutrient control modules 14 and/or HVAC modules 16.

A number of grow modules 10 are connected to a nutrient control module 14 and a HVAC (Heating Ventilation and Air Conditioning) module 16 to create a field 26. As illustrated in FIGS. 1 and 2, field 126a consists of grow modules 12a, 12b, 12c and 12d, nutrient control module 14a and HVAC module 16a. Similarly field 126b consists of grow modules 12e, 12f, 12g and 12h, nutrient control module 14b and HVAC module 16b.

With a completely enclosed environment, deconstructive interference between grow modules 12 of the same field 26 is removed (i.e., 12a, 12b, 12c, 12d) and interference between grow modules of different fields 26 is eliminated (i.e., 12a and 12e). Closed modules 12 prevent light from one grow module 12 affecting the darkness period of another grow module 12. Additionally, preventing an operator 28 from unnecessary UV exposure. Closed loop circulation prevents the humidity and/or temperature of one grow module 12 from negatively affecting another grow module 12. This deconstructive interference is a factor that prevents the true efficiencies and diversity of crops 32 from being accurately monitored and exploited.

The grow module 12 of the soilless growing system 10 is intended to facilitate the full crop growth cycle, from seed 102 to harvestable crop 32. This is different to other systems that typically employ a number of different systems/platforms for the various growth stages.

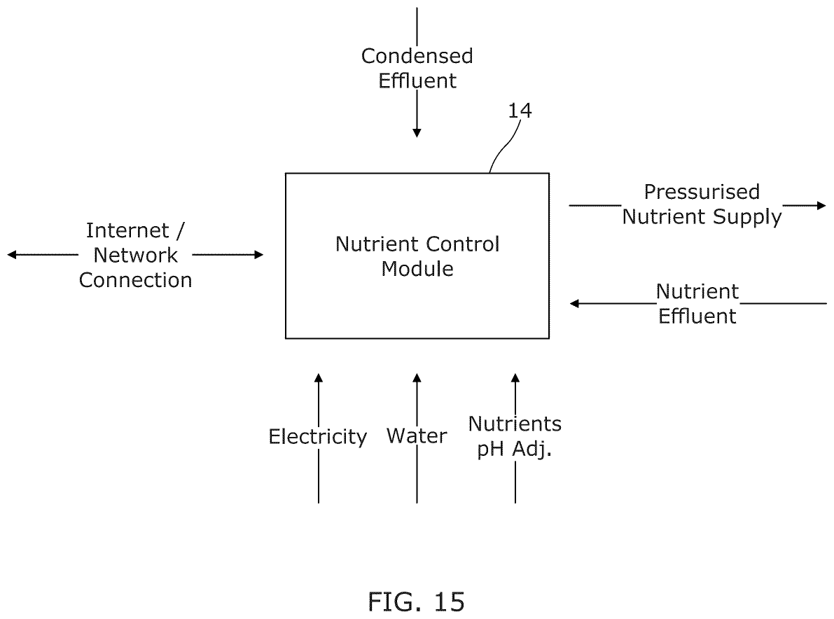

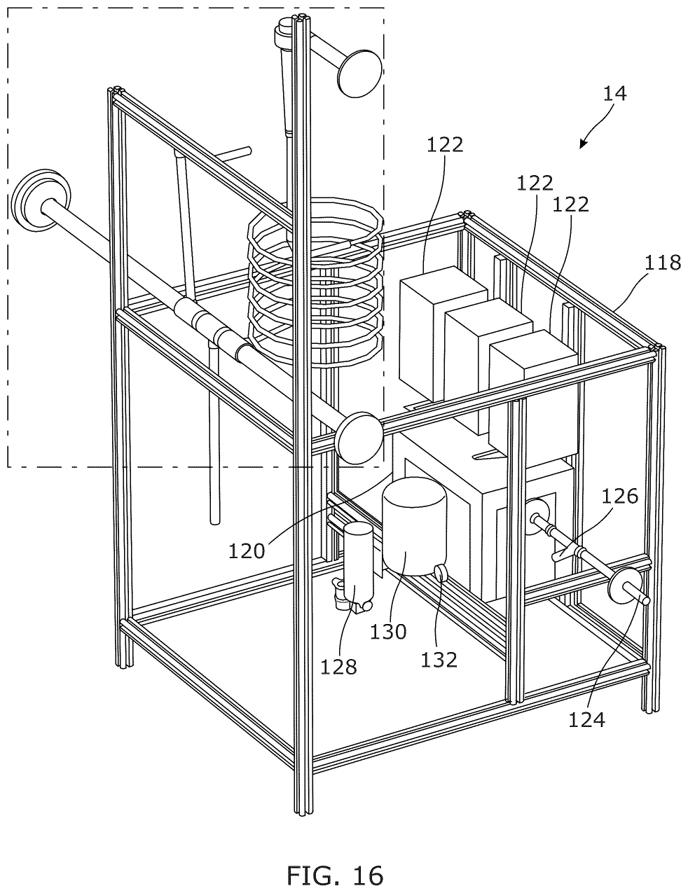

The nutrient control module 14 of the soilless growing system 10 comprises a frame 118 (see FIG. 16) onto which the appropriate components are mounted and, at its core, the nutrient control module 14 provides a pressurized supply of nutrients to the connected grow modules 12. The nutrient control module 14 also collects and cleans the nutrient effluent from the connected grow modules 12, and monitors and regulates the nutrient, pH and conductivity levels within the nutrient supply. Further details of the nutrient control module 14 are set out in FIGS. 15 and 16.

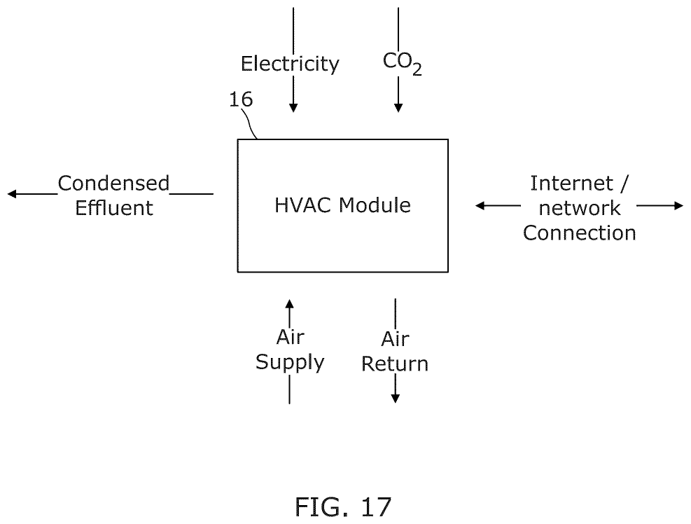

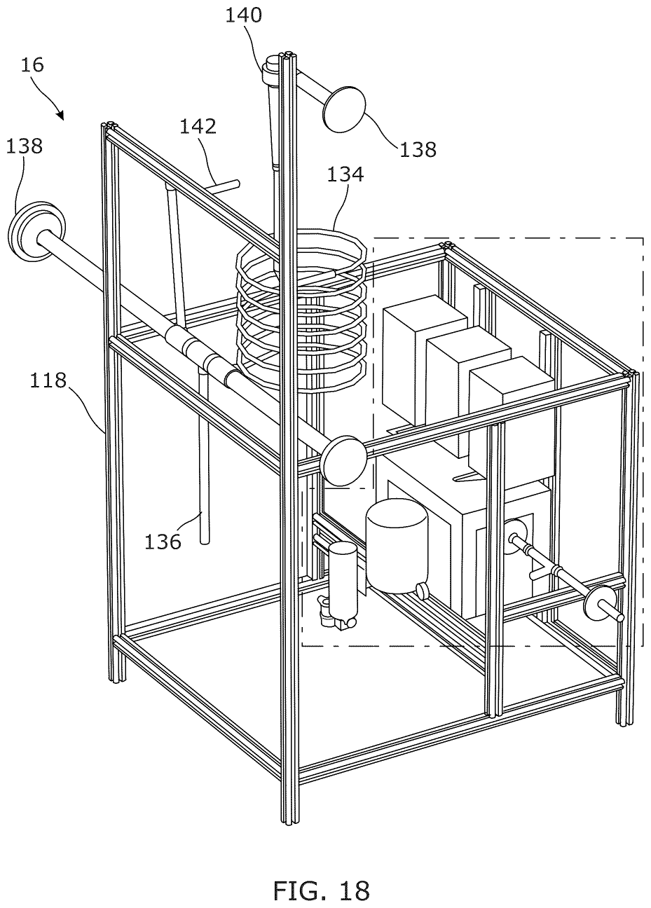

The HVAC module 16 of the soilless growing system 10 handles and conditions the air (gaseous environment) within the system 10, and is described in detail in FIGS. 17 and 18.

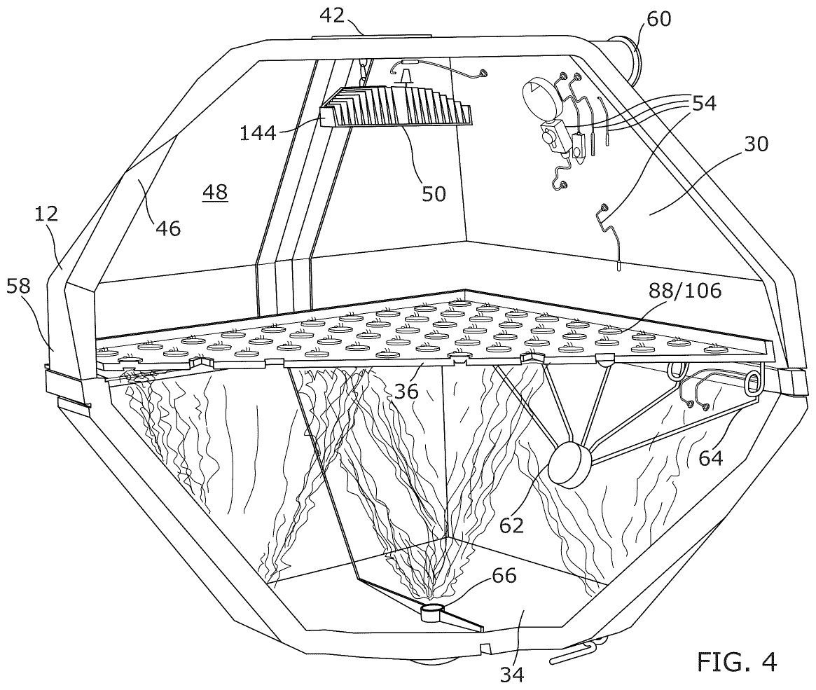

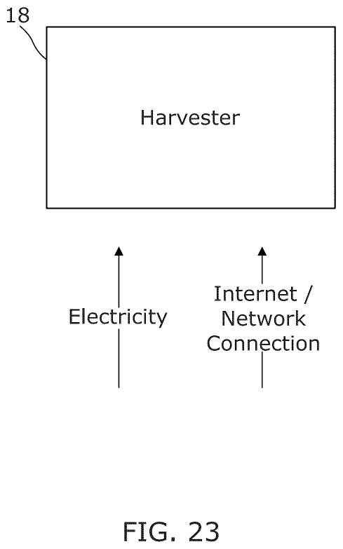

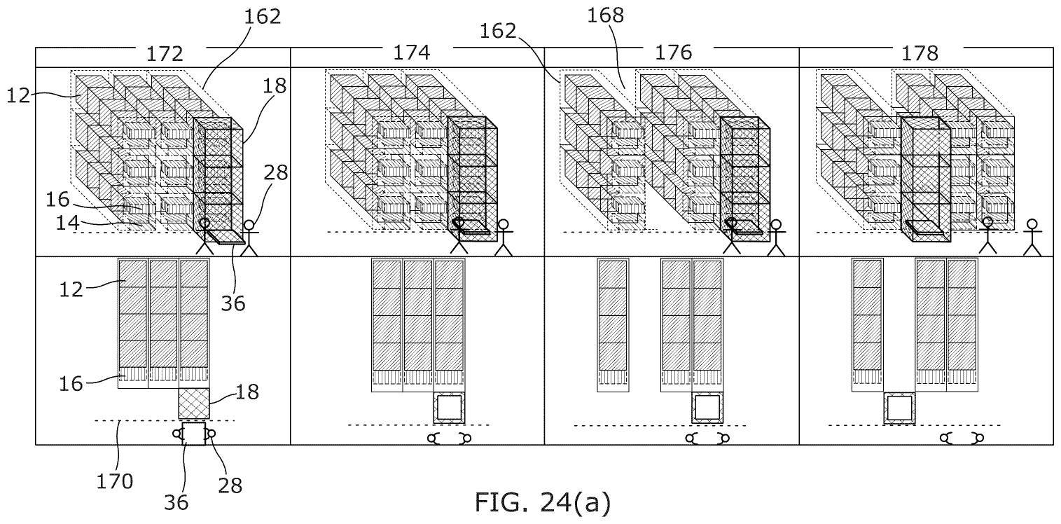

The modular soilless growing system 10 also comprises a harvester module 18 which transfers the grow bed 36 (as described in relation to FIGS. 4 and 5) from a processing area 20 to and from an individual grow module 12. Further detail on the harvester 18 is set out in FIGS. 23 and 24. As shown in FIG. 1, the processing area 20 can include an output module 22 into which the harvester 18 can place the grow bed 36 with grown crops 32 for onward processing and despatch.

The harvester 18 can also collect a freshly-seeded grow bed 36 from an input module 24 within the processing area 20. Whilst the harvester 18 was loading and unloading the next grow bed(s) 36, the plants 32 in the grow bed 36 in the output module 22 can be removed (either manually or autonomously). The empty grow bed 36 would then be transferred to the input module 22, and seeds 102 inserted/planted, prior to transfer by the harvester 18 to the individual grow module 12, and so on.

The skilled person will appreciate that the particular configurations of modules making up the soilless growing system 10 can take any number of formats and configurations. FIG. 1 is illustrative of placing the fields 26 longitudinally to form an aisle 162 of 3 levels although this is in no way intended to be limiting, as the modular soilless growing system 10 can be employed in any manner so as to maximize the number of modules within the bounds of the internal structure (not shown) in which the system 10 is situated.

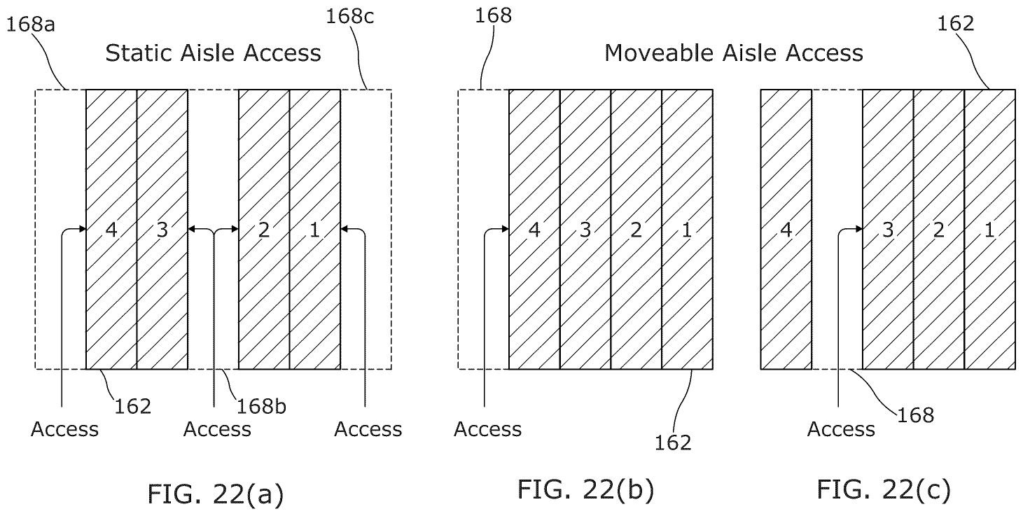

FIG. 2 is a high-level schematic diagram of the modular soilless growing system of FIG. 1, and shows the inputs and outputs thereto. In one embodiment of the invention, each nutrient control module 14 and HVAC module 16 is each connectable to four grow modules 12a, 12b, 12c, 12d. This creates a “field” 26a. The fields 26 are arranged into aisles 162 (see FIG. 22) which then allows ease of access to each of the grow modules 12. The harvester 18 is used to collect and deliver grow beds 36 to and from grow modules 12. The operator 28 (or automation system) places crops 32 in, or removes them from, the grow bed 36. Further detail of each of these modules of the modular soilless growing system 10 is described below.

FIG. 3 is a high-level schematic diagram of the primary grow module 12. At its core, the grow module 12 comprises an enclosed volume which has a controlled environment within which the crops 32 can grow. The grow module 12 receives or transmits various inputs and outputs which control the supply of nutrients to the crops 32, controls the supply of light 50 to the crops 32, and collects and disseminates sensor 54 information.

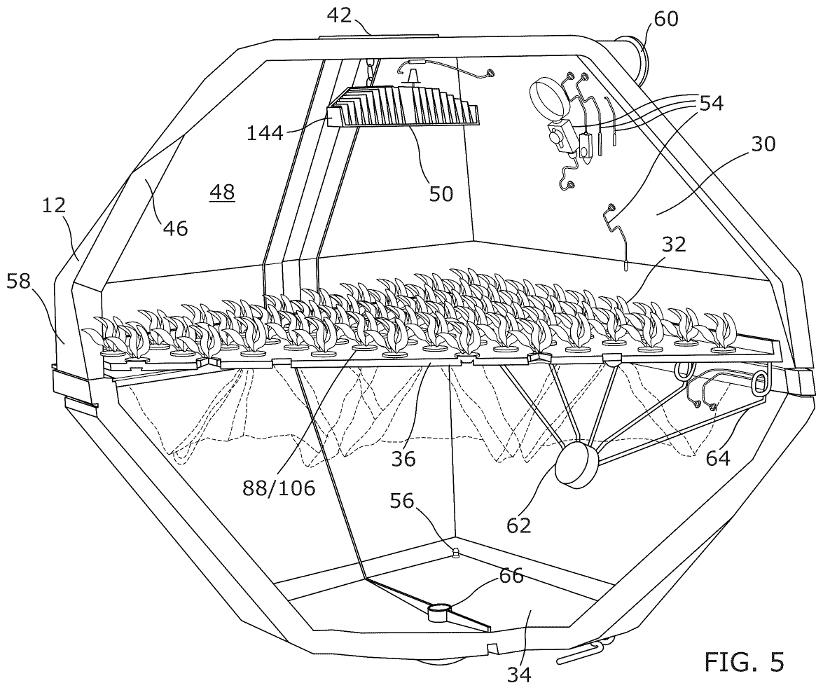

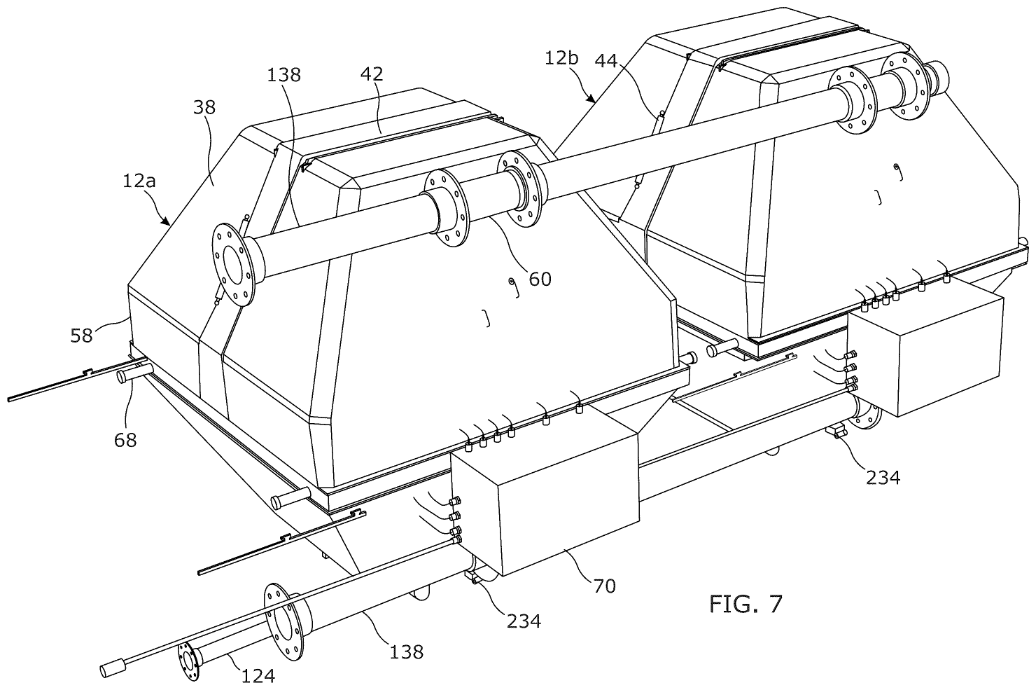

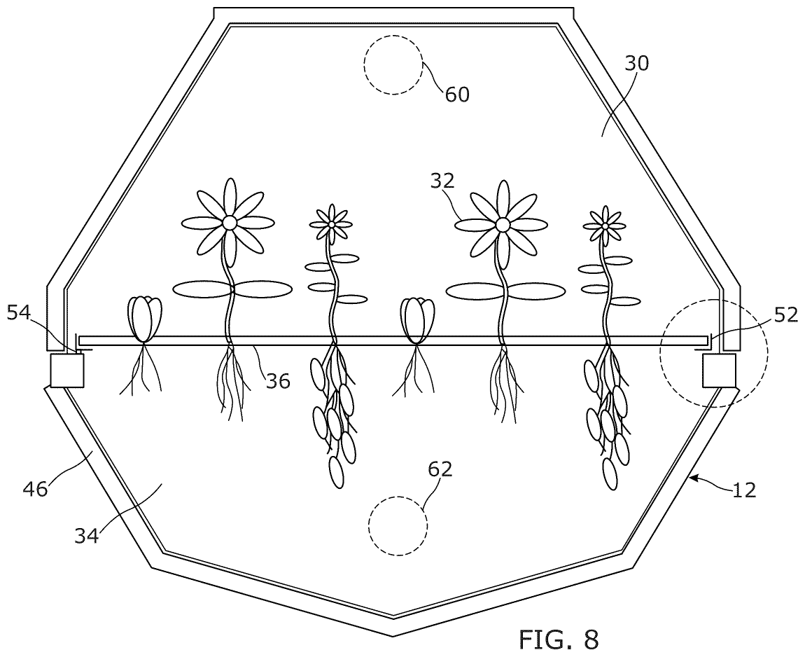

FIGS. 4 and 5 show front cutaway views of the primary grow module 12, and FIG. 6 illustrates a front perspective view of the primary grow module 12 showing the grow bed 36 and access door 38 omitted for clarity purposes. In a preferred embodiment, the shape of the grow module 12 generally being an elongated square bifrustum. This is in no way intended to be limiting as in use any number of geometric configurations can be utilized, such as a triangular bipyramid, cuboid, rectangular cuboid, pentagonal bipyramid, hexagonal bipyramid and/or any suitable polyhedral shape etc. What is evident from FIGS. 4 to 6 is that the grow module 12 is an enclosed volume being roughly divided into two parts, namely an upper volume 30 into which the crops 32 are supported and can grow, and a lower volume 34 into which the roots of the crops 32 are periodically sprayed with atomized nutrient solution. Separating the upper volume 30 from the lower volume 34 is the removable grow bed 36 which supports the crop 32. Further details of the grow bed 36 are described in relation to FIGS. 8 and 9.

The skilled person will also understand that the vertical “hipped” section 58 of the grow module 12 immediately above the bed 36 provides a crucial function. For the module 12 to allow the bed 36 to be removable whilst simultaneously allowing beneath bed growth; it must be possible to lift the grow bed 36 vertically before moving it in the horizontal plane. The “hipped” shape 58 therefore allows the removal of the bed 36 whilst reducing damage or interference to beneath-bed crop growth.

The grow module 12 has a relatively tall profile, both above and below the bed 36. The advantage of a taller profile is that the system 10 it is not restricted to a specific type of crop 32. Where the crop 32 type is broadly categorized by on-bed, above-bed and below-bed, having a single module 12 capable of growing all three types (optionally at the same time) provides tremendous potential for economies of scale.

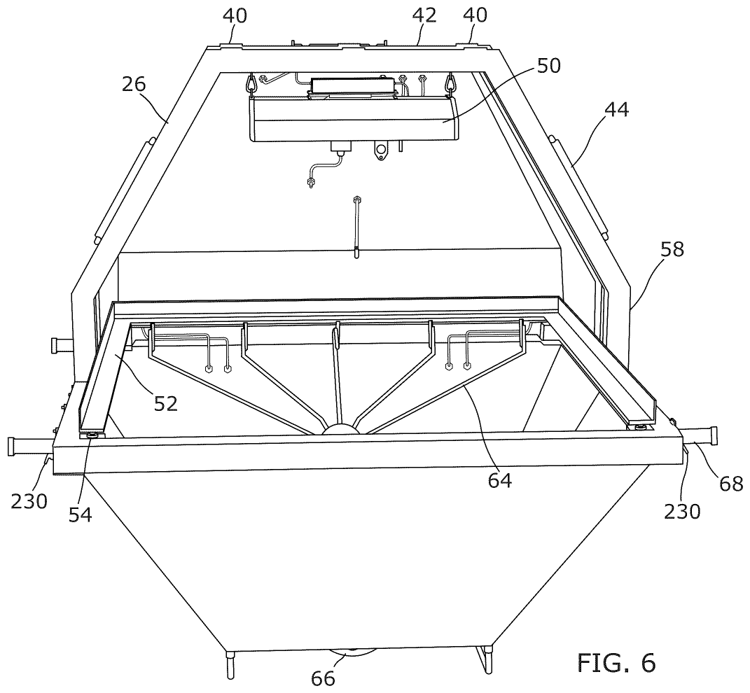

The grow module 12 is “air-tight” which provides a number of advantages. Namely all evaporative water losses can be recaptured, the carbon dioxide (CO2) concentration within the module 12 can be increased and the grow environment is separated from the surrounding external environment. The grow module 12 has a shell design that encompasses a door 38 which hinges 40 from the roof 42 (as best shown in FIG. 7) with a latching mechanism 230 enabling a repeatable, air-tight seal. The door 38, being hinged 40 at the top is supported by gas struts 44. This allows easy access to the crops 32, when needed. The latching mechanism 230 also allows the harvester 18 to unlock and lock the grow module 12 autonomously.

The grow module 12 is insulated 46. Typically, known growing enclosures struggle to remove heat that is predominately generated by the lighting. Crucially, the present invention removes the heat in a different way, closed-loop circulation, in contrast to ambient dissipation. The advantage this provides is that the temperature of the building/structure within which the system 10 is situated can be much more varied. It also means that grow modules 12 of individual fields 26 can be operated at different temperatures, which facilitates the growing of a diverse range of crops 32.

Furthermore, insulating the grow module 12 ensures that all internal surfaces 48 are roughly the same temperature, which reduces cold spots and significantly reduces the amount of internal condensation. Condensation above the grow bed 36 is unwanted as it enables unwanted above-bed growth, for instance algae and/or mold. Especially during a photoperiod, the above-bed environment is extremely humid. Preventing condensation within the grow module 12 prolongs this high humidity period, and enables the circulation system to capture the evaporative losses.

The internal surfaces 48 of the grow module 12 are highly reflective (either white or mirrored) and this helps to boost the efficiency of the lighting 50.

The grow bed 36 is situated upon a weigh frame 52 and load sensor 54 which provides a number of crucial functions. Primarily, the weigh frame 52 allows the mass of the grow bed 36 to be monitored. This provides a secondary metric for monitoring crop 32 growth progress (in addition to camera/image processing in the sensors 54). It should be noted that weighing the crops 32 enables all types of crop 32 growth to be monitored (above- and below-bed 36) which the above-bed camera system 54 cannot undertake.

The weigh frame 52 provides sealed air circulation interface points 228 for the grow bed 36, directing the air flow through the grow bed 36; whilst still allowing the weighing to take place.

The weigh frame 52 allows the grow bed 36 to be removed and replaced.

The weigh frame 52 prevents (almost entirely) the transmission of light from the above-bed area 30 to the below-bed area 34. This is a crucial factor in reducing unwanted beneath-bed growth, for instance algae and/or mould. The beneath-bed area 34 are prime locations for unwanted growth to take place, because it is warm and moist. As such, mitigating or reducing the amount of light that penetrates below, reduces unwanted growth and leads to less maintenance and/or cleaning.

The weigh frame 52 significantly reduces the amount of mist/spray from spraying nozzles 56 reaching above the bed 36. In the same way as unwanted growth can occur beneath the bed 36, it can also occur above-bed 30. The only wetted surfaces above the bed 36 should be the points where the crops 32 are growing. This prevents unwanted growth above the bed 36, again reducing maintenance and/or cleaning.

FIG. 5 shows that the grow module 12 contains four spray nozzles 56 from which a mist is created. Impingement nozzles are used to provide a uniform and reasonably wide-angled spray pattern. The size of the droplets here is also key, the very fine droplet size created by this nozzle is beneficial and more efficient for root uptake. The high pressure required to make such a nozzle function ultimately reduces the rate of blockages within the nozzles 56. The mist produced from these nozzles is reasonably high velocity making it unsuitable for shallow applications, but ideal for a “taller” module 12. This type of nozzle 56 also removes the need for an additional compressed air-line, and thereby reducing complexity. Although particular embodiments refer to a grow module 12 having four spray nozzles 56, the skilled person will understand that this is in no way intended to be limiting as, in use, the present invention can be configured having any number of spray nozzles 56.

FIGS. 4 to 9 also show details of an air circulation interface 60 being situated above the grow bed 36, and an air circulation interface 62 situated below the grow bed 36. As described in further detail below, this is to enable greater circulation beneath the crop canopy 74 and enable extraction/supply of airflow directly beneath the canopy 74. The present invention utilizes a perforated grow bed 36 that allows air to travel through the bed 36 using channels 76 disposed within the bed 36 itself. The arms/ducting 64 of the air circulation interface 62 below the bed 36 supply/remove air from the bed 36, as described in further detail below in relation to FIG. 9.

The sensors 54 in the above-bed area 30 can include sensors for monitoring the crop growing process; and these can include sensors which measure temperature, humidity, CO2, camera images, illumination, etc. This list is in no way intended to be limiting.

Each grow module 12 also comprises a nutrient effluent interface 66 which collects the nutrient effluent from connected grow modules 12 and passes it to the nutrient control module 14 for cleaning and recirculation.

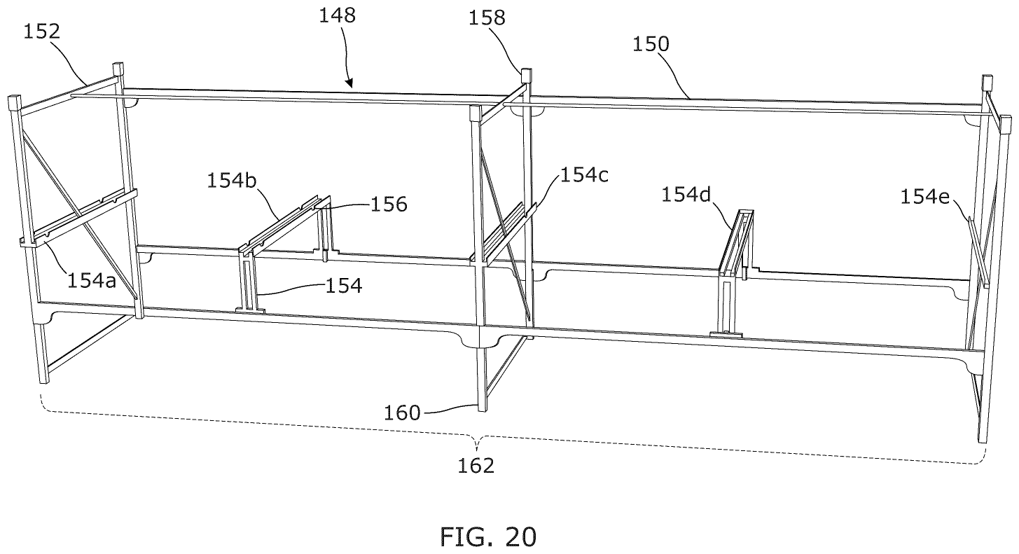

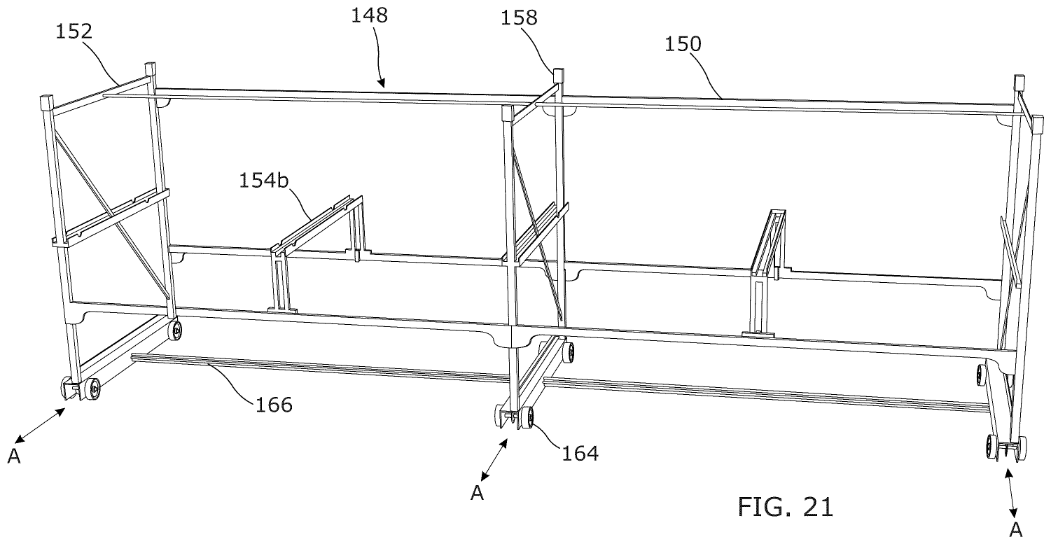

As best shown in FIG. 6, which depicts a grow module 12 with the insulation 46, grow bed 36 and access door 38 removed for clarity purposes, each grow module 12 includes a plurality of mounting points 68 which are used to secure and move the module 12 into, and out of, the racking 148, as is described in further detail below in relation to FIGS. 20 and 21.

As perhaps best shown in FIG. 7, electrical connections to each of the grow modules 12 is made via an electrical panel 70 disposed generally at the rear thereof. FIG. 7 also illustrates various pipework, ducting and flanges (shown schematically as numeral 138) that can be connected between neighbouring grow modules 12 to convey treated air from the HVAC module 16 to connected grow modules 12a, 12b and so on. Likewise, nutrient solution is conveyed from neighbouring grow modules 12a, 12b to the nutrient control module 14 via conduit 124. A similar line (not shown) conveys pressured nutrient solution to connected grow modules 12 from the nutrient control module 14 at specific points 234.

FIG. 9 is a high-level side cross-sectional view of the grow bed 36 of the grow module 12. The grow bed 36 of the soilless growing system 10 is perforated and contains internal ducting 76 to allow the removal/circulation of air under the crop canopy 74, which provides a significant advantage in terms of preventing unwanted mould and/or algae growth and increasing crop 32 yield, as set out below.

Air circulation methods employed within known soilless growing systems rely on fans to circulate air above the plant canopy 74. The aim of this is two-fold; firstly to provide direct cooling of the plants leaves and secondly to provide enough turbulent airflow to disturb the canopy 74 and provide some circulation/airflow beneath the canopy 74. This area beneath the canopy 74 (the underside of the leaves) is crucial, as it is where the plant's leaves absorb CO2 and expel O2. Without sufficient air circulation/flow beneath the plant canopy 74 the concentration of CO2 reduces and O2 increases. This leads to suboptimal conditions for photosynthesis and effects the system's 10 efficiency as a whole.

Known measures used to counteract this phenomenon include stronger fans and restricting crop density. Stronger fans create more turbulence and force the air further into and beneath the canopy 74. However stronger airflow requires more electrical energy and can damage crops. Restricting the crop density allows the area between crops 32 to remain open and allow clear “paths” to the areas beneath the plants leaves, and effectively preventing the formation of a dense canopy 74. The drawbacks of reducing crop density are that it reduces the potential revenue density and also enables crops 32 to grow uncompetitively; sprawling and spindly. It is understood that close competition of crops 32 enables tighter leaves, more concentrating the flavour and uniformity of the harvested product.

The present invention however takes a different approach to enable greater circulation beneath the crop canopy (the area generally circled as 232 in FIG. 9) via extraction/supply of airflow supplied by fan 72 located within the HVAC module 16. The approach utilizes a perforated grow bed 36 that allows air to travel through the bed 36 using channels 76 within the bed 36.

Although the circulation depicted in FIG. 9 shows extraction through the bottom of the grow bed 36, the system can also be configured to allow extraction through the top of the grow bed 36 (reverse-flow direction). The grow bed 36 must allow crops 32 to penetrate through the bed 36 whilst preventing loss, or impact, on the effectiveness of the ducting 76. The grow bed 36 must also only provide extraction/supply of airflow at the top side 30 of the bed 36 or at specific (bed-frame 36-52) interface points 228 beneath the bed 36, to prevent excessive mist from collecting within the channels 76 or ducting 64 which could lead to unwanted mould and/or algae growth.

In one embodiment of the invention, the grow bed 36 is formed using three layers of plastic sheet, shown schematically as a top layer 78, middle layer 80 and lower layer 82 in a sandwich-like construction. Each sheet 78, 80, 82 being cut to a different pattern to produce the required channel pattern 76. In the current version of the grow bed 36, an aluminium support backing (not shown in FIG. 9) is also used to support the sandwiched layers 78, 80, 82 together and also provide rigidity. To reduce costs, and to maximise the number of crops 32 that may be grown, then alternative constructions can be utilised.

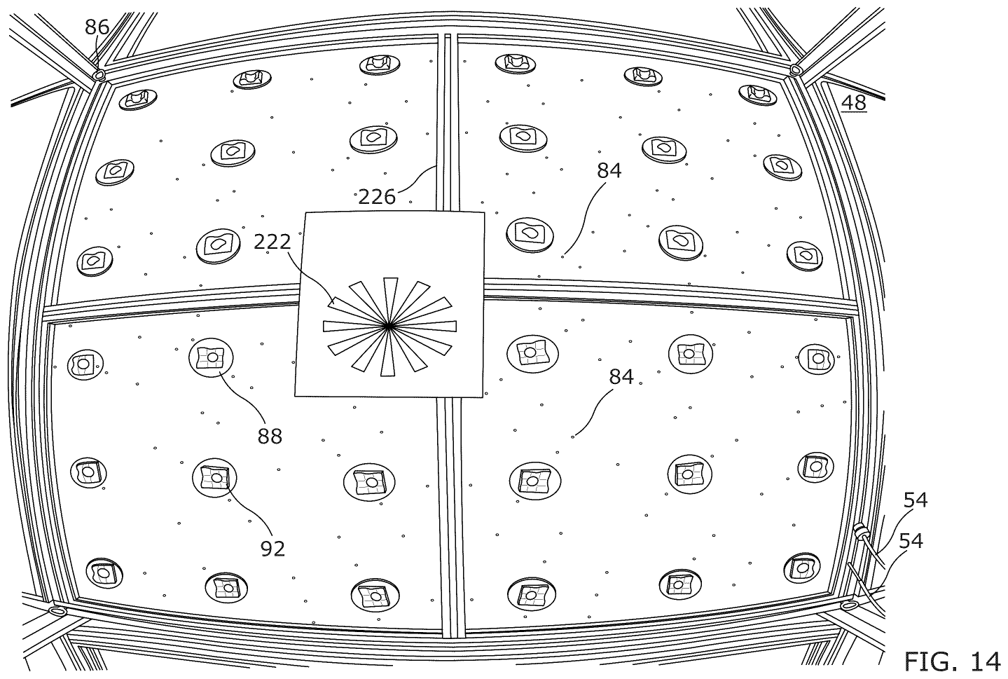

As perhaps best shown in FIG. 14, the grow bed 36 can be configured having a peripheral frame 226 that divides the bed 36 into four quarters. Each quarter of the grow bed 36 is supplied/extracted at the corner point thereof via opening 228 and the arms/ducting 64 of the air circulation interface 62 to supply/remove air from the bed 36. The weight of the grow bed 36 placed onto the weigh frame 52 and the use of a flexible surface provides a reasonably leak-tight connection for the air to circulate therethrough.

The holes 84 in the top layer 78 are strategically placed and sized to provide a uniform flow across the entirety of the bed 36 (as best shown in FIGS. 9 and 14). The top layer air hole 84 diameters are varied based upon the distance from the interface point 228. With the air holes 84 closest to the interface point (corner) smaller than those closest towards the center of bed 36.

The grow bed 36 also utilizes lifting eyes 86, one in each corner of the bed 36, to provide a means by which to move the bed 36. The skilled person will understand that this is in no way intended to be limiting as, in use, the bed 36 can be designed to be lifted from underneath.

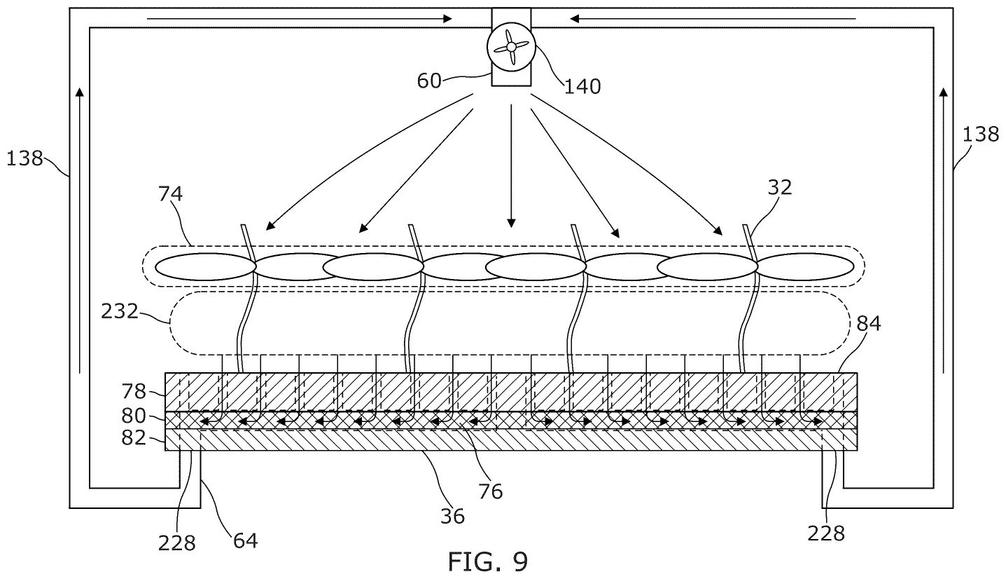

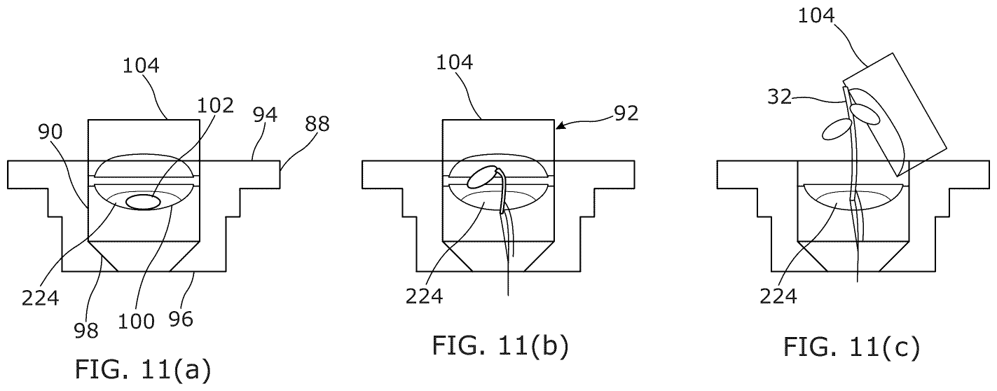

FIGS. 10a and 10b are side and top plan views, respectively, of a crop holder 88 that is receivable in the grow bed 36, as perhaps best illustrated in FIG. 12. The crop holder 88 being annular in shape having a centrally-disposed opening 90 that, in a preferred embodiment, is square-shaped in cross section for receiving a substrate 92. The opening 90 runs completely through the top surface 94 of the crop holder 88 to the bottom surface 96 thereof. Such an opening 90 allows air and nutrient flow across the seedling/crop 32. The opening has a sloped inner edge 98 that is used to prevent the substrate 92 from falling completely through the opening 90 when in use, the gradient allowing drainage from the substrate 92.

Typically, a substrate 92 is required in order to propagate the seed 102. The substrate 92 performs a number of essential functions. It provides an environment within which to anchor the crop 32. It provides a consistently moist environment from which the seed 102 and seedling 32 can withdraw nutrients and water.

The substrate 92 also prevents a number of problems. Primarily the substrate 92 is a common area for unwanted mould and/or algae, by wilful intention the conditions on the substrate 92 are as close as possible to optimum for facilitating plant 32 growth. Substrates 92 are also an additional consumable that either have to be cleaned for reuse or replaced, incurring additional cost. The substrate 92 can also degrade with use and can pollute and or block the nutrient return lines.

With known aeroponics systems, crops are typically transplanted from nursery substrates into a second substrate after reaching early maturity. This allows any unwanted mould/algae to be removed but requires an additional manual action, per crop. Transplanting is difficult as the seedling roots are delicate and care must be taken not to effect further crop growth. Typically nursery substrates are common for a larger number of seedlings: 10s to 100s of seeds. Following maturity they are transplanted to individual substrates. Finally, the finished crops must be removed from the substrate and any debris from the substrate removed from the crops. Again this action is manual, difficult and time-intensive.

The crop holder 88 and substrate 92 of the present invention however provides an environment within which the seeds 102 can grow completely without transplanting. This reduces the number of manual actions required and reduces the likelihood of spread of mould and algae growth.

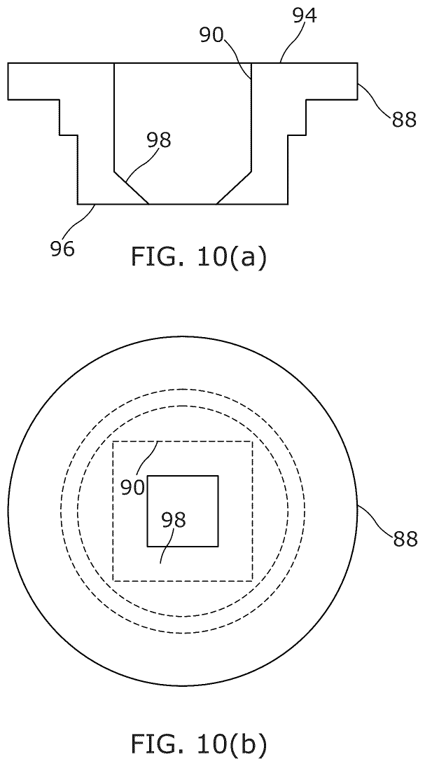

In a preferred embodiment, the crop holder 88 uses a foam substrate 92, as shown in FIGS. 11a, 11b and 11c at various stages of seedling growth. The foam substrate 92 being generally cuboid-shaped having a bowled concaved top surface 100 and a slit running through the entire depth (not shown). The concaved shape 100 locates the seed(s) 102 and starting nutrient mixture droplet 224 to be located and held in place, as shown in FIG. 11a. As the seed 102 germinated the roots would penetrate through the foam substrate 92 (assisted by the slit). Once the roots protruded beneath the foam substrate 92 they would be exposed directly to the mist beneath. A second, inverted foam substrate 104 is placed on top of the assembly to shield the initial nutrient droplet 224 from direct light. Enough light penetrates the substrate to allow the seed 102 to germinate. Once germinated, the seedling 32 “pushes” the top substrate 104 out of place, as shown in FIG. 11c. A variety of foam densities and porosities can be used. FIG. 12 is a perspective view from the side and above of the crop holder 88 of FIG. 10 with a seedling growth 32 on a foam substrate 92.

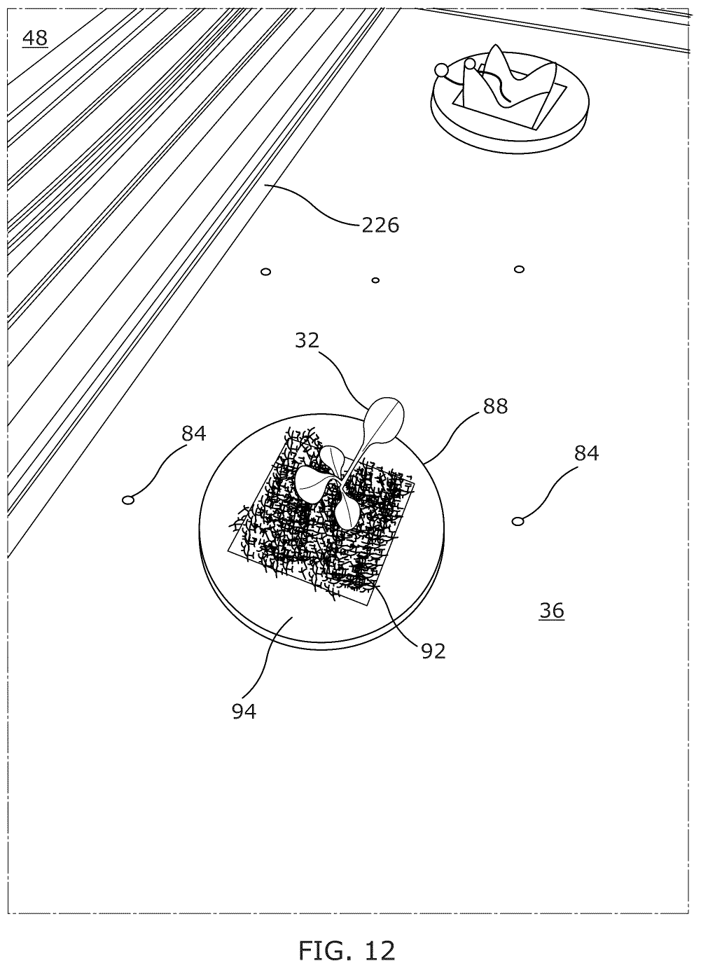

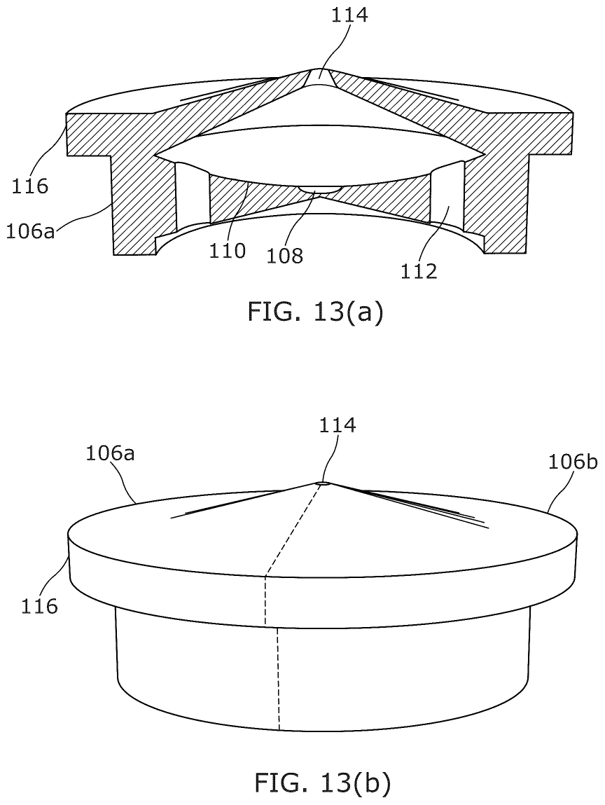

FIG. 13a is a perspective view from the side and above of one half of an alternative crop holder 106a according to an embodiment of the present invention, and FIG. 13b showing the alternative crop holder 106 assembled from the two identical abutting halves 106a, 106b. The crop holder 106 does not use a substrate at all. The two identical pieces 106a, 106b are placed face-to-face to form the crop holder 106. A carrier ring (not shown) keeps the two halves 106a, 106 together, and provides a mechanical interface point for supporting the crop 32.

The method for growth within this crop holder 106 is similar to that of the previous crop holder 88. The seed(s) 102 will be placed in the central indentation 108 with a droplet of nutrient mixture (not shown). The indentation 108 is present at the bottom of concaved surface 110 to allow additional mist to collect with the seed(s) 102. The basin 110 also reduces the likelihood that the seed is lost through the mist inlet. Initial root growth progresses towards the mist inlets 112. The germinated seedling protrudes through the light inlet 114 where the cotyledons are exposed to the full illumination. Whilst the root area remains in darkness.

As the crop growth continues and the crop strengthens; the roots part the two lower surfaces whilst the cotyledons and upper stem press against the inside surface of the light inlet 114. Once the crop reaches full maturity removing the crop holder from the carrier ring (not shown) allows the holder parts 106a, 106b to be separated and the crop 32 to be released.

The shoulder 116 makes a seal on the grow bed 36 to prevent light penetration beneath the grow bed 36. It also allows location of the carrier ring (not shown).

The holder 106 is 3D-printed from flexible filament. In addition, the holder 106 can be moulded from a silicone-type material. The material can be blue coloured and magnetically susceptible to allow easy identification of any debris from the holders 106 that is created.

Other holder 106 embodiments may use more pieces to allow an easier separation. Future versions may also employ an angled light inlet 114 to prevent direct light transmission on to the initial seed droplet. It should be noted that the carrier ring (not shown) provides the option for automated collection and placement of crop holders 106 within the grow bed 36. Other versions of the carrier ring may protrude vertically above the crop holder 106, some 20 cm to 30 cm above to facilitate crops which are grown above-bed 36, e.g., strawberries and the like.

Building on the advantages of the substrate filled crop holder 88, the substrate-less crop holder 106; removes further manual operations (the crop must no longer be separated from a substrate), reduces waste and sources of contaminants (substrate is no longer a consumable) and further prevents unwanted algae/mould growth.

FIG. 14 is a photographic image obtained from the camera 54 disposed at the top of the grow module 12 aimed at the grow bed 36. Note, this image was taken from the camera within the system 10 as part of the focusing/set-up. A wide-angle lens is required to fit in the entire bed 36 due to the limited height. Furthermore, since the light 50 occupies the central position (to achieve uniform crop growth) therefore the camera 54, shown for illustrative purposes in FIG. 4, must be placed off-centre. FIG. 14 also shows that a focussing chart 222 can be used on initial set-up to focus the camera 54, as is known to someone skilled in the art. The images taken from the camera 54 being used for monitoring the crop 32 growing process.

FIG. 15 is a high-level schematic diagram of the nutrient control module 14. At its core, the nutrient control module 14 handles the nutrients within the system 10. The nutrient control module 14 comprises a frame 118 onto which the appropriate components are mounted, as best shown in FIG. 16. The opaque area of FIG. 16 being the HVAC module 16, which is detailed in relation to FIGS. 17 and 18.

The nutrient control module 14 has three main functions. It provides a pressurized supply of nutrients to the connected grow modules 12. It collects and cleans the nutrient effluent from the connected grow modules 12 and it regulates the nutrient, pH and conductivity levels within the nutrient supply.

The provision of fresh water, nutrients and pH adjusters can be manual or automatic. The use of these inputs (to regulate the nutrient solution) is always automatic. The nutrient control module 14 employs a number of sub-systems in order to appropriately enrich and monitor the nutrient supply.

The nutrient control module 14 comprises an intermediary nutrient reservoir 120, within which the conductivity and pH are monitored. In a further embodiment of the invention, this functionality may be extended to include turbidity monitoring. Having an intermediary reservoir 120 has a number of benefits. It allows the amount of stored solution at any point to be minimized; reducing weight. It creates a faster response in system conductivity and pH; both a reduction from crop usage and an increase from nutrient addition. This enables more accurate monitoring of crop nutrient usage and being more controllable. An agitator (not shown) may also be included to increase the rate of homogenization within the reservoir 120.

Fresh water, nutrients and pH regulators (up/down) are stored in intermediate vessels 122, and dosed into the nutrient reservoir 120 using peristaltic dosing pumps (not shown). The reservoirs 122 could alternatively be replaced with constant (“plumbed-in”) supplies. Separating the solution elements maximizes longevity and reduces wastage.

The condensate run-off 136 from the HVAC module 16 (FIG. 18) connects to the nutrient reservoir 120 and is returned under gravity. In such away, evaporative losses are almost entirely eliminated.

The entire arrangement of the nutrient control module 14 is made such that it is lower than the lowest point of the grow modules 12 so that the solution, once sprayed within a grow module 12, returns to the nutrient control module 14 under gravity. This reduces the need for pumps, increasing the electrical efficiency of the system. The nutrient effluent flows 124 through a filter trap 126 before falling into the nutrient reservoir 120. In alternative embodiments, the nutrient control module 14 may employ a recirculation line that pumps a small portion of the reservoir 120 through a more intensive cleaning mechanism, for example, an ultraviolet (UV) light/filter arrangement and/or one or more additional filter stacks.

The nutrient control module 14 comprises a diaphragm pump 128 to pressurize an intermediary storage vessel 130. The intermediary storage vessel 130 contains a diaphragm (not shown) which expands as the pump 128 forces solution in. This pressurized storage allows for the pump 128 to operate intermittently; as opposed to pumping for every individual spray for each grow module 12. This type of pump 128, being designed to operate intermittently, reduces the number of pumping cycles which will help to prolong its life. Furthermore the internal diaphragm roughly regulates the pressure generally between 4 to 6 bar, allowing consistency between successive sprays. The small changes in pressure should provide an advantageous variation in mist and droplet velocities to further increase uniformity of the root coverage. A pressure gauge 132 can also be included with the intermediary storage vessel 130.

Where possible, the reservoirs 120, 122 and all effluent, should be retained within opaque containers to prevent light ingress and unwanted algae and/or mould growth.

FIG. 17 is a high-level schematic diagram of the HVAC module 16. At its core, the HVAC module 16 handles the air (gaseous environment) within the system 10. The HVAC module 16 comprises a frame 118 onto which the appropriate components are mounted, as best shown in FIG. 18. The opaque area of FIG. 16 being the nutrient control module 14, which is detailed in relation to FIGS. 15 and 16. In a preferred embodiment, the HVAC module 16 is depicted as being mounted on same frame 118 as the nutrient control module 14, but this is in no way intended to be limiting.

When provided with the required inputs/outputs the HVAC module 16 provides several functions. It provides a circulated supply of air within the system 10. It monitors and regulates the CO2 concentration of the air (and adds CO2 as needed). It monitors and regulates the humidity of the air. It monitors and controls the temperature of the air (removes heat) within the system 10. Finally, it collects and returns any condensate.

The provision of CO2 can be manual or automatic. The use of this input (to regulate the CO2 concentration) is always automatic.

FIG. 18 shows a conceptual drawing of the HVAC module 16. The skilled person will also appreciate that many of the features needed to provide optimum thermal properties and air quality are not shown in the drawings for reasons of clarity. The HVAC module 16 employs a number of sub-systems in order to appropriately manage the atmospheric environment. Due to the “open” nature of most known prior art growing environments, this is usually undertaken by standard HVAC units. However, with the present invention, the HVAC module 16 modularize and discretize these functions into a single platform, tailored for closed loop circulation.

The HVAC module 16 comprises a heat exchange element 134 (depicted here as a coil) which is flown through intermittently, the proportion of flow through the heat exchanger 134 is varied to control the temperature and humidity of the air/atmosphere. Using a heat exchanger 134 ultimately condenses the humid air, and reduces humidity. Alternative embodiments may employ a cyclone to separate humidity from temperature control.

Condensate is collected at the lowest point within the system 10 and returned to the nutrient control module 14 under gravity via the condensate run-off 136.

The HVAC module 16 comprises flow and return headers 138 that allow the air/atmosphere within the grow modules 12a, 12b, 12c, 12d of one field 26 to be shared via a fan 140. This is advantageous as it allows for constructive interference between the grow modules 12. Typically the grow modules 12 photoperiods (and heat generation periods) will be offset within a field 26. As such, the thermal energy and humidity of a single grow module 12 can be shared across the field 26.

The heat exchanger 134 exchanges energy with a secondary fluid, either through piped-connection or residence within a bath (not shown). This secondary fluid provides temporary thermal storage. Centralised heat recovery systems can be installed to collect the heat from this secondary fluid, allow distribution of heat between fields 26 or for sale and additional revenue streams. Once the secondary fluid is heated, it can be used to heat the connected grow modules 12 when the temperature falls. Typically the issue is removing heat, however as the grow modules 12 are closed they can be placed in more-exposed environments.

The HVAC module 16 also possesses the option for a CO2 connection 142, either via compressed bottle or plumbed-in. Due to the grow modules 12 being air-tight, increasing the concentration of CO2 within the growing environment is not only safer, but also more efficient. Increasing the CO2 content of the grow module 12 boosts the rate of photosynthesis. In open grow environments, humans are present and therefore adjusting the CO2 concentration is a safety issue. Humans are not intended to reside within the grow modules 12, and as such, this particular concern is eliminated. Safety measure will still be required. The air-tightness of the system 10 significantly reduces the losses of CO2 to ambient.

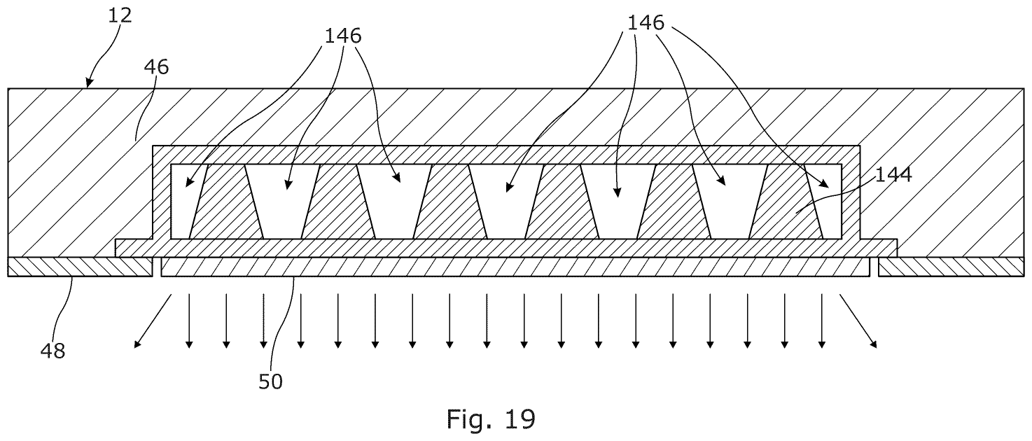

FIG. 19 illustrates a side cutaway view of an alternative way of removing heat from the light source 50 in the grow module 12 and which can be fed back to the HVAC module 16, typically via the circulation headers 138 or similar. At the moment the heat is dissipated into the grow module 12 and then the excess removed by the HVAC module 16. In a preferred embodiment, the light 50 passively cools itself since the heat sink 144 is large enough to remove the heat via convection only. There is no need for forced convection, providing the ambient temperature remains low enough.

In an alternative embodiment, the light 50 will actually form part of the boundary of the module 12. The light 50 side would be inside the internal surface 48 of the grow module 12, but the heat sink 144 would be outside the insulation layer 46. A cooling fluid, which could be water, can then pass-through passages 146 in the heat sink 144. This way the heat is still captured, but is not dissipated into the grow module 12 itself. Again, this heat recovery system can collect the heat from the grow module 12, allow distribution of heat between fields 26 or for sale and additional revenue streams.

FIG. 20 shows detail of a racking 148 that can support the grow modules 12, nutrient control module 14 and HVAC module 16 and other components thereon.

The two main benefits of the racking 148 are that it is modular and moveable. The modularity allows the fields 26 to be stacked vertically and extended longitudinally, creating aisles 162 of fields 26. Optionally, the racking 148 can be mounted on a trolley 164 to permit movement thereof, as shown in FIG. 21. This enables the aisles 162 to be moved in a single plane; the advantage of this is that space between aisles 162 can be removed when not in use, reducing the footprint of the system 10 inside the building/structure within which it is situated.

As shown in FIGS. 20 and 21, the racking 148 primarily consists of vertical 152 and horizontal 150 pre-engineered components that connect together in a modular, systematic manner. In particular, the racking 148 comprises a generally horizontal spanning member 150, the ends of which being receivable between pairs of vertical frame members 152. Positioned approximately halfway the vertical height of each frame member 152 is a module support arm 154 which, in use, receives the mounting points 68 of the grow module 12, for example.

Interposed between the frame members 152 is positioned a module support arm 154, such that two grow modules 12 can be located between successive spans of vertical frame members 152. This can be visualized as follows in relation to FIG. 20 in that a first grow module 12a (not shown) is supportable between module support arms 154a and 154b, a second grow module 12b (not shown) is supportable between module support arms 154b and 154c, and so on.

Each module support arm 154 includes a number of apertures or notches 156 which receive the male mounting points 68 of the grow module 12 when in use. The notches 156 locate the grow modules 12 which facilitates expansion and removal for maintenance.

The racking 148 is flat-packable and can be assembled on-site. The three basic parts; span members 150, module supports 154 and vertical frames 152 can all be disassembled.

The racking 148 is also vertically stackable, with female connections 158 at the upper end of the vertical frame members 152 and male connections 160 at the lower end of the vertical frame members 152.

The assembled racking 148 is therefore an open frame, facilitating access.

As shown in FIG. 20, the racking 148 connects longitudinally to create connected aisles 162 of fields 26. The racking 148 shown in FIG. 20 has been configured for a single field 26 comprising five support arms 154a, 154b, 154c, 154d, 154e which can support four grow modules 12a, 12b, 12c, 12d (not shown).

As shown in FIG. 21, the racking 148 can also be placed on wheeled trolleys 164 which allow the aisles 162 to move in one plane, denoted as “line A”. A drive shaft 166 is connected between the trolleys 164 so as to ensure aisles 162 remain parallel when in use.

FIG. 22a shows a plan view from above which illustrates how the racking 148 of FIG. 20 can be configured to provide static access aisles 168; and FIGS. 22b and 22c illustrate how the racking of FIG. 21 can be configured to provide moveable aisle access 168 and thereby maximizing crop yield per unit area. It can be seen in FIG. 22a that additional space (bounded by the dotted line) required for three aisle gaps 168a, 168b, 168c needed to access four growing aisles 162 is greater when the aisles 162 are static. The moveable aisle access 168 shown in FIGS. 22b and 22c provides significant advantages as it allows a higher density of grow beds 12. Effectively only one moveable aisle gap 168 is required for any number of aisles; compared with one gap 168 for every other aisle (assuming aisles 162 are placed back-to-back as is shown in FIG. 22a).

FIG. 23 is a high-level schematic diagram of the harvester 18 of the soilless growing system 10. When provided with the required inputs/outputs, the harvester 18 takes grow beds 36 from processing area 20 to particular grow modules 12. It retrieves grow beds 36 from grow modules 12 and brings them back to processing area 20, and it can move grow beds 36 between grow modules 12.

The harvester 18 is an apparatus that can also be used to facilitate the addition and removal of grow beds 36 from grow modules 12. In one embodiment of the invention, it could be moved and operated by the operator 28. However, an autonomous harvester 18 that automatically identifies the next grow module 12 for harvesting, moves to that position, removes the grow bed 36, brings the grow bed 36 to the processing area 20, is entirely within the scope of the present application. This is depicted schematically in FIGS. 24a and 24b.

The harvester 18 has the ability to add and remove grow beds 36 from grow modules 12 which are stacked without the need for operators 28 to work at height. This is a significant advantage, as it increases both safety and consistency.

The harvester 18 is able to operate the release and latching mechanism 230 on the door 38 of the grow module 12 such that it is able to operate autonomously.

The harvester 18, being mechanically attachable to the aisles 162, such that it can only move up and down the aisles 162 along the aisle gap 168, or along the end face of the aisles 162. In this way, limiting the movements of the harvester 18 makes automation easier. The harvester 18 also being vertically extendable.

The automated version of the harvester 18 is capable of removing and placing grow beds 36 within grow modules 12 without any direct supervision by the operator 28. Where applicable, the harvester 18 will interface with the aisles 162 to arrange them correctly. Under these circumstances, the aisle areas 162, 168 will be out of bounds for the operator 28. FIGS. 24a and 24b illustrate schematically how the harvester 18 can be used in conjunction with the moveable racking aisles 162 of FIG. 21 to load and unload individual grow modules 12.

Alternatively, a manual version of the harvester 18 is capable of removing and placing grow beds 36 within grow modules 12 at the ground level under guidance of the operator 28. The harvester 18, being wheeled, will be moveable into position by the operator 28.

In the following description each step of FIGS. 24a and 24b will be referred to as “S” followed by a step number, e.g. S172, S174 etc.

In the first step, at S172, the operator(s) 28 loads seedling/crop 32 in crop holders 88/106 into/onto the grow bed 36.

At S174, the populated grow bed 36 is placed into the harvester 18.

At S176, the harvester 18 interfaces with the aisles 162. The appropriate aisles 162 are moved to leave an aisle gap 168.

At S178, the harvester 18 propels itself to the appropriate aisle gap 168 along the end face of the aisles 162.

At S180, the harvester 18 propels itself down the aisle gap 168 to the appropriate field 26 and grow module 12.

At S182, the harvester 18 raises the grow bed 36 up to the height of the appropriate field 26 and individual grow module 12.

Finally, at S184, the harvester 18 places the grow bed 36 inside the grow module 12 prior to returning to the starting position.

Dotted line 170 delineates a “no-go” area ensuring operator 28 safety, which in the preferred embodiment would be a physical barrier/fence (not shown for clarity).

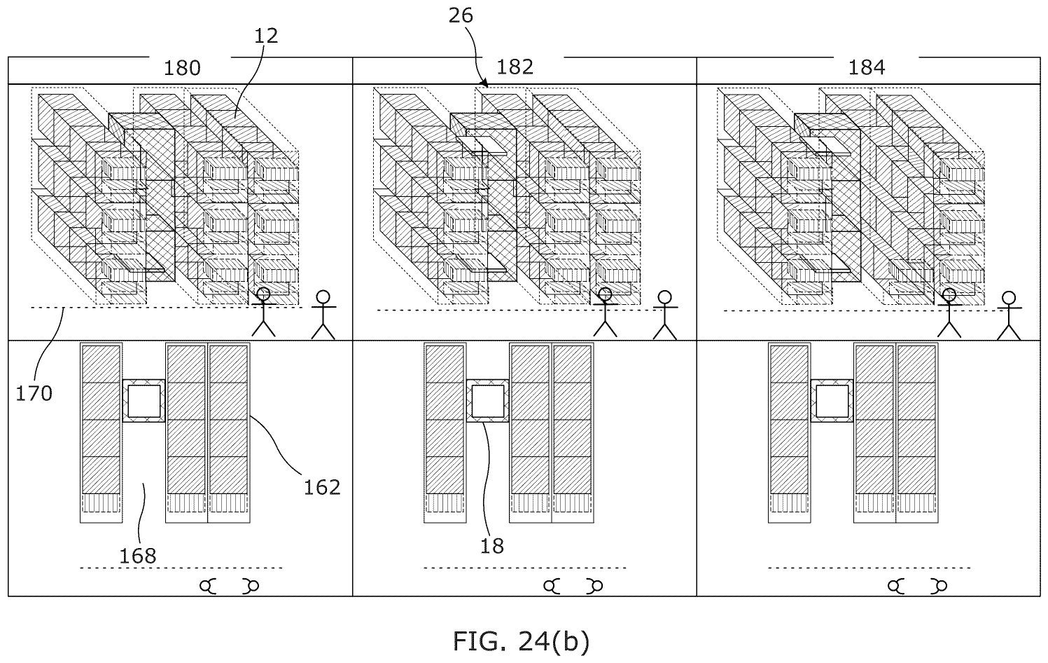

FIG. 25 outlines schematically how crops 32 are grown and harvested using the modular soilless growing system 10 described herein. Referring to FIG. 25 the actual use of the modular soilless growing system 10 will now be described.

At S186, one or more seed(s) 102 are placed into a crop holder 88/106.

At S188, crop holders 88/106 containing seeds 102 are placed on to the grow bed 36, typically up to 100 crop holders 88/106 can be placed on to a single grow bed 36.

At S190, the grow bed 36 is placed into the harvester 18.

At S192, the harvester 18 carries the grow bed 36 from the processing area 20 to the correct grow module 12 and places the grow bed 36 within the grow module 12.

At S194, the grow module 12, nutrient control module 14 and HVAC module 16 collaborate to provide optimum conditions for growth. Growth time is dependent upon crop 32 type, but is approximately 20 to 45 days. During the growth cycle (S194), the plants could also be transplanted to different grow beds 36 to enable better distribution of the light between plants 32 and allow room for growth. However, introducing additional re-transplanting steps should be carefully considered to ensure that the inefficiencies introduced when re-transplanting do not overshadow the initial benefit.

At S196, the harvester 18 retrieves the grow bed 36 from the grow module 12 and carries it back to the processing area 20.

At S198, the grow bed 36 is removed from the harvester 18.

At S200, the crop holders 88/106 containing crops 32 are removed from the grow bed 36.

At S202, the grown crops 32 are removed from the crop holder 88/106, prior to post-processing (quality control, aesthetic trimming, cleaning, shipping, etc.)

The skilled person will appreciate that this process and the soilless growing system 10 being modular in nature provides inherent economies of scale, improves waste heat recovery and crop densities, and is variably automatable depending upon the resources available. As described herein, the modular soilless growing system 10 can be operated manually, or each of the modules of the system 10 have the ability to be individually automated.

Some of the modules have the ability to be automated, with an optional add-on, or can be operated manually. Operators 28 are able to purchase the cheaper, manual systems initially and subsequently upgrade.

One example of this is the harvester 18 and aisle 162 movement. These modules can be operated completely manually such that the operator 18 moves the relevant aisles 162, with a large turn wheel at the end of the aisle 162. The operator 28 then moves the harvester 18 to the desired location. The operator 28 utilizes the harvester 18 to place or remove a grow bed 36 from the grow module 12.

Alternatively, with the upgrades, these actions can be undertaken completely autonomously such that the system 10 determines which grow module 12 is next to be accessed. The system 10 adjusts the aisle positions 162 to allow access to the desired grow module 12. The harvester 18 propels itself to the appropriate location and performs the required action, replacing or removing the grow bed 36, etc.

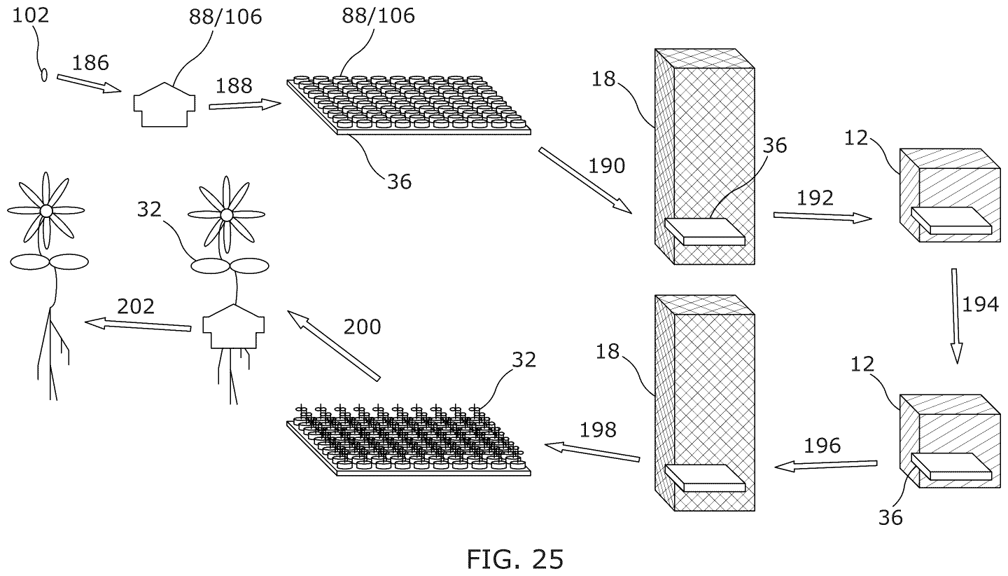

FIG. 26 is a high-level illustration of how machine learning can be utilized to optimize crop yield in an automated system 10. As described herein, the system 10 comprises a relatively large number or array of sensors 54 per crop, including, but not limited to, camera images, humidity, temperature, CO2, illumination, grow bed mass, etc. The data collected from the system 10 is used to monitor and control the growing environment. Techniques, such as machine learning, can also be envisaged to allow the system 10, at S206, to compare how differences in the “recipes” effect crop growth from the collected data at S204.

At S210, the system 10 will vary the recipe for each grow module for each batch of crops at S212 slightly across operators 28, individual grow modules 12 or fields 26. Variation within the farm of a single operator 28 is advantageous as differences in external influences are removed. Gradually the variations from the so-called optimum recipe can be assessed and the optimum recipe updated at S208. Due to the large datasets generated; number of variables, number of users and quality of feedback it is highly unlikely that such patterns can be robustly determined by human intervention. As such, the implementation of machine learning (neural-networks or similar) can be used to determine the optimum recipes.

The skilled person will also understand that the main input for this closed growing system 10 is electricity. Electricity is the prime factor in determining the economic viability of any artificially illuminated crop irrigation system 10. Any improvements which enable less, or cheaper, electricity to be used are therefore extremely valuable.

In one embodiment of the invention, it is feasible that the electricity supplier could be granted some degree of control over the amount of electricity being used. In return, the electricity supplier would provide better tariff rates. Depending upon the growth stage of the crops 32, a photoperiod of 1 to 16 hours is generally required. As an example, assuming the crops 32 needed an 8-hour photoperiod, the electricity supplier would be permitted to shift the 8 hours within an allowable window or perhaps split, reduce and maybe even cancel photoperiods for individual grow modules 12.

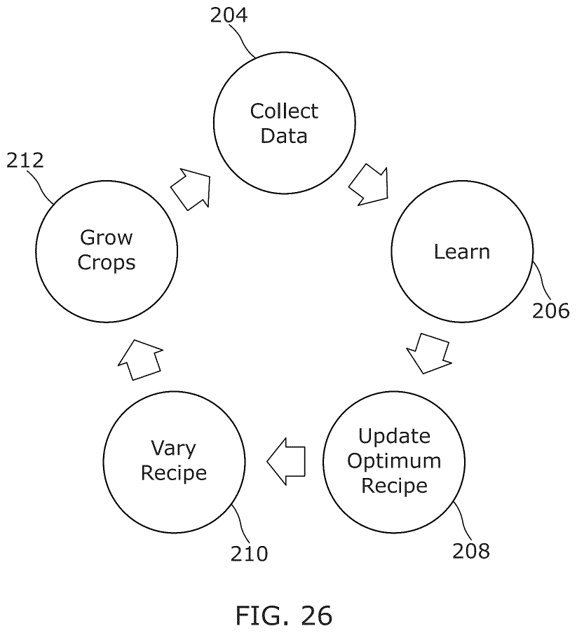

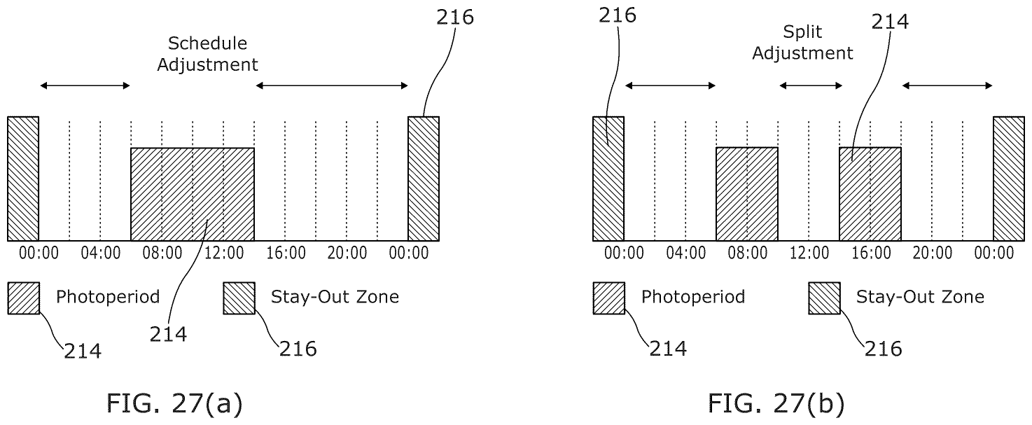

FIGS. 27a and 27b show two different options for load scheduling, with FIG. 27a showing that the photoperiod can be moved between allowable limits, and/or FIG. 27b showing that the photoperiod can be split throughout the day. FIG. 28 shows that such load scheduling shown in FIGS. 27a and 27b can have an effect on the load.

FIG. 27 show two options for how the electrical load to the modular soilless growing system 10 can be adjusted, simply moving the photoperiod 214 between allowable limits (FIG. 27a) or splitting the photoperiod 214 and adjusting (FIG. 27b). Stay-out zones 216 are determined by the previous photoperiod, ensuring a minimum dark time. In one embodiment, the stay-out zones 216 are arbitrarily set to the start, and end, of the day.

The interface for the electricity supplier would be as simple as possible. In effect, they would be given three choices; to use early, defer or reduce use. In this way, the system 10 could determine the best actions to take.

Using the mechanisms described above, the system 10 would aim to achieve a flat load level by default. The large number of individually-controlled grow modules 12 allows unprecedented load levelling at the system 10 level.

The electricity supplier can also select deviations away from this nominal load. In the example shown in FIG. 28, the nominal load 218 is maintained as flat as possible by default. The electricity supplier might wish to promote consumption in certain hours, in this example between 16:00 and 04:00, and set the load profile request 220 accordingly.

Alternatively, the electricity supplier could simply set the tariff rate per hour and allow the system 10 to use the cheaper hours as best as possible. The pricing mechanism and quantifying any crop 32 deterioration or slowed progress due to such actions is key. Machine learning can assist in understanding the exact impact of such load changes thereby giving a quantifiable measure.

Any load scheduling constraints stipulated by the electricity supplier and the data capture from the sensors 54 of the system 10 are inputted to an application software. The application software allows the system 10 to be monitored and controlled on-site via a computing device. Such devices generally comprise a processor which is connected to a memory, and a communications interface. Off-site viewing and monitoring is also possible. In this way, the communications interface is configured to send signals from the sensors 54 to a web viewer/user interface (UI) and/or data can be uploaded to a cloud or server for further processing and analysis.

Information about each of the grow modules 12, etc. as monitored by the system 10 can be accessed via the application software or user interface embodied on a computing device or mobile communications device which is uniquely connected to the system 10. In a preferred embodiment, the user interface can be operated to select and monitor a single grow module 12, or other parts or modules of the system 10. The user interface can display photo images, real-time live images, sensor values, etc. More complex graphical user interface options, including visual and audible alarms/status indicators for humidity, temperature, CO2, illumination, crop weight, electrical load etc. are envisaged.

Therefore, the modular soilless growing system 10 according to the present invention and its method of use provides the optimum conditions for crop growth in a closed aeroponics system that reduces external contamination, and mitigates CO2 enrichment safety issues. The soilless growing system being modular in nature which provides inherent economies of scale, improves waste heat recovery, crop densities and is variably automatable depending upon the use of conditions.

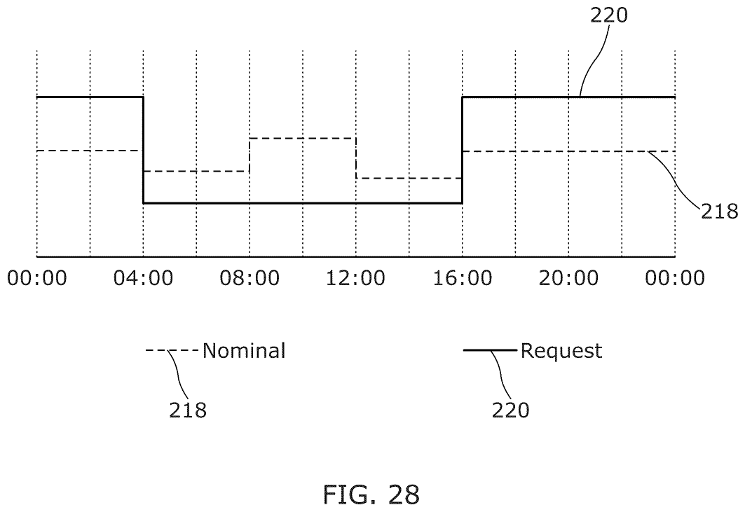

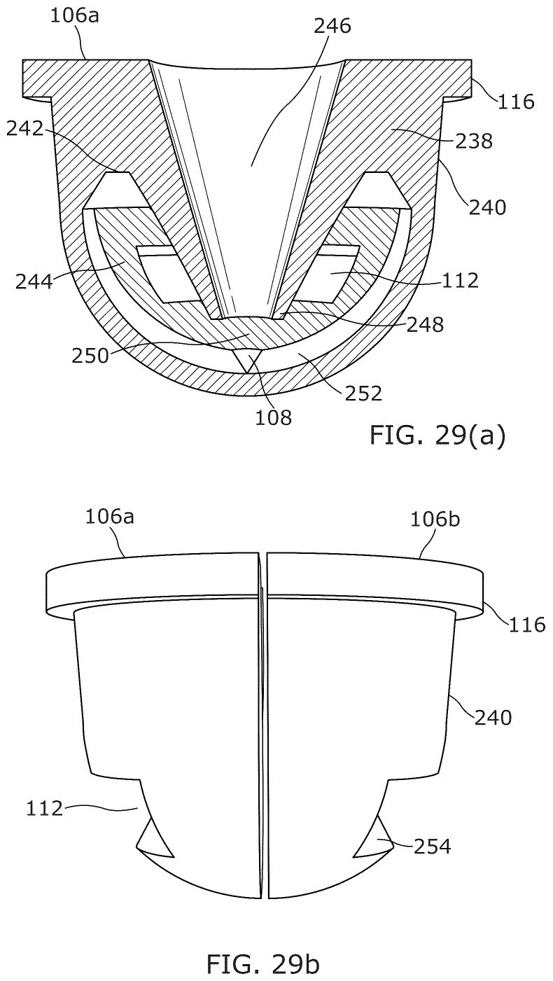

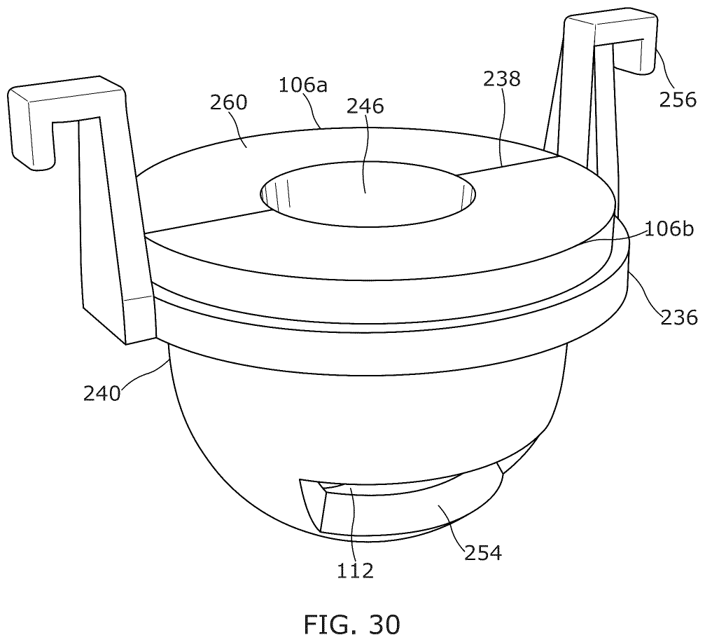

FIGS. 29 and 30 show a second embodiment of a substrate-less crop holder 106. The construction of the second embodiment of the substrate-less crop holder 106 is very similar to that of the first embodiment and corresponding features have been given the same reference numerals. The second embodiment differs from the first embodiment in terms of its shape and geometry, which provides a number of useful attributes and features, as described below.

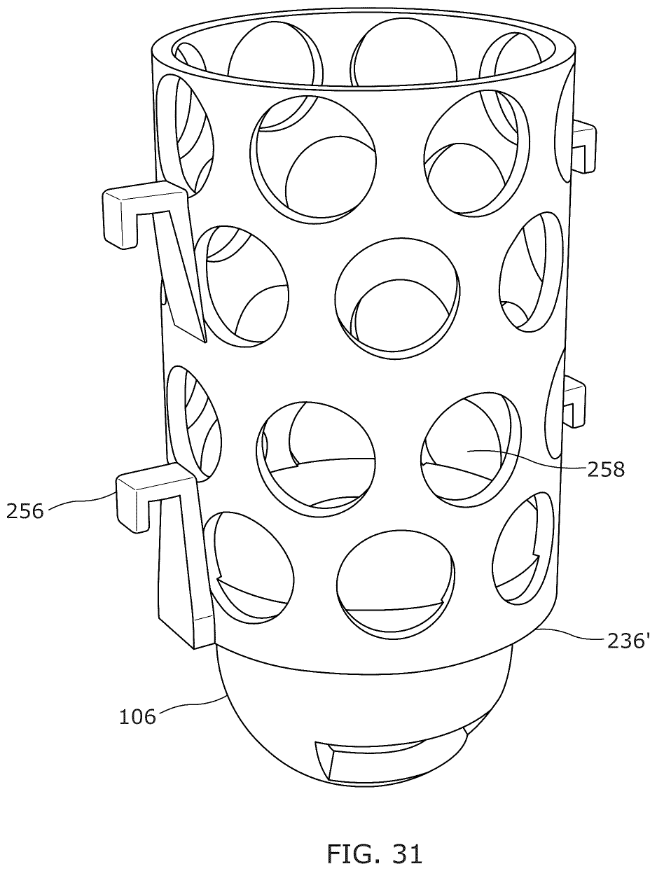

Very much like has been described above in relation to FIGS. 13a and 13b, FIG. 29a is a side plan view of one half 106a of an alternative crop holder 106, and FIG. 29b shows the alternative crop holder 106 being assembled from the two identical abutting halves 106a, 106b. Again, like the first embodiment, the substrate-less crop holder 106 is formed from molded silicone, which can be colored blue to make it more easily discernible. As best shown in FIG. 30, a carrier ring 236 retains the two halves 106a, 106 together, and which can also be extended, as shown as ring 236′ in FIG. 31, to provide a mechanical interface point for supporting the growing crop (not shown).

The two halves 106a, 106b are held together by the carrier ring 236 which is rigid in nature. The carrier ring 236 can be produced using any number of plastic-forming techniques for mass production. The carrier ring 236 serves three important functions:
1. It retains the two halves 106a, 106b of the holder 106 pressed together.
2. It provides a tangible pick-up point for automated handling.
3. It provides an optional above ground structure for crops to grow in to.

It should be noted that the above ground structure is influenced by the needs of the crop 32, and hence it is envisaged that different crop holder carrier rings 236, 236′ may be used for different crop 32 types. Furthermore, portions of the surface of the carrier ring 236 can be embossed/marked with a unique identifier to allow automatic tracking and tracing of crop 32 progress. This information can be fed back into the neural-network.

In use, the two identical pieces 106a, 106b of the crop holder 106 are placed face-to-face to form the crop holder 106. A smooth interfacing face 238 promotes good sealing (water and light tight) between the two halves 106a, 106b of the crop holder 106. The top shoulder 116 provides a robust mounting, and supporting and locating mechanism for the carrier ring 236 and/or grow bed 36 directly.

The outer sides 240 are tapered to promote a tolerance fit for the carrier ring 236 and/or grow bed 36. This creates a force to squeeze or compress the two halves 106a, 106b together. It should be noted that this tapered side 240 may subsequently be modified such that it is different in perpendicular planes, relative to the sealing face 238. This facilitates a different squeezing (compressive) force in the sealing (face-to-face) plane than in the non-sealing plane.

As best shown in FIG. 29a, an upper portion 242 of the inside surface of the inner cavity 244 is rounded to direct and promote condensation of spray that reaches the inner cavity 244. A central conical tube 246 allows the ingress of light, for crop growth, whilst enabling even a small canopy 74 to completely block light from penetrating beneath the grow bed 36. The height of the conical tube 246 enables even stretched (sometimes referred to as “leggy”) seedlings to be supported during early growth stages.

Each crop holder half 106a, 106b possesses a mist inlet hole 112, allowing mist from beneath the holder 106 to penetrate the holder cavity 244. It should be noted that mist is prevented from directly passing through the holder 106 and in to the above bed 36 grow area.

The conical tube 246 has a tip 248 which protrudes lower than the bottom of the mist inlet 112. This allows the tip 248 to be submerged in a small reservoir of nutrient solution, contained within the basin 250 formed at the lower surface of the inner cavity 244. By being spherical in nature, the basin 250 allows pooling of any captured/condensed mist. The lower parts 252 of the sealing face 238 are bevelled and indented to promote root growth that separates and penetrates through the bottom of the crop holder 106, as described in further detail below. The mist inlet holes 112 also have bevelled edges 254 to promote run-off, as best shown in FIG. 29b.

FIG. 30 illustrates that the carrier ring 236 has a bottom annulus opening which, through a tolerance fit, compresses the two halves 106a, 106b of the crop holder 106 together when in use. Two (or more) interface points or projections 256 protrude from the lower annulus of the carrier ring 236 and thereby facilitating automated pick-up and carry.

FIG. 31 shows a further variation of the carrier ring 236′ which can be implemented with extended above bed structures to accommodate above bed 36 growth of particular crops 32. The extended section of the carrier ring 236′ is perforated with a number of holes 258 to allow ingress of light and supporting points for the crop canopy 74.

The crop holder 106 and carrier ring 236, 236′ can be used in the following manner. It should be noted that variations of certain aspects, or steps, may be required for crops 32 with larger seeds 102.

The two halves 106a, 106b of the crop holder 106 are placed together and fitted inside the annular opening of the carrier ring 236. The assembly is then placed within one of the holes arranged in the grow bed 36. Interference between the sides of the carrier ring 236 and/or hole in the grow bed 36 provides a compressive force which seals the two halves 106a, 106b of the crop holder 106 together along the interfacing faces 238.

The basin 250 is filled with nutrient solution via the conical tube 246. The filled basin 250 holds a small reservoir of nutrient solution (not shown in the drawings), the upper surface of the reservoir of nutrient solution is generally level with the lower edge of the mist inlets 112. It is worth noting that the crop holder 106 cannot be filled above this level. The tip 248 of the conical tube 246 is submerged within the basin reservoir 250.

One or more seeds 102 (but not shown in any of FIGS. 29 to 31) are then inserted into the crop holder 106 via the conical tube 246. The seed(s) 102 cannot escape through the mist inlets 112 providing the reservoir of nutrient solution in the basin 250 is maintained; and the seed(s) 102 float on the level within the conical tube 246.

The seed(s) 102 germinate and are supported by the conical tube 246. Evaporative losses of the nutrient reservoir of the basin 250 are replenished by mist which is captured and condensed by the inside surface of the inner cavity 244. The canopy of the crop 32 grows thereby placing the inside of the tip 248 in darkness and preventing light penetration to the basin 250. Crop root growth, promoted by the bevelled face features 244, then works its way through the sealing faces 238.

As root growth continues, the lower portion of the flexible sealing faces 238 are separated and, eventually, the basin 250 reservoir is emptied. The roots within the cavity 244 continue to receive nutrient mist through the mist holes 112, whilst the roots protruding through the holder 106 receive nutrient mist directly.

It should be noted that once the bottom sealing faces 238 are separated, light penetration to beneath the bed 36 is prevented by the crop canopy 74. The crop 32 is held in place by the compressive force of the lower sealing faces 238, the inner surface of the conical tube 246 and/or, in some circumstances, the upper face 260 of the holder 106. As crop growth continues, the holder 106 is further deformed providing a strong anchoring point for the crop 32 whilst continuing to separate above, and beneath, the grow bed 36. Depending upon the crop 32 type, the canopy 74 may grow into the extended carrier ring structure 236′.

Once fully grown, the assembly can be easily removed from the grow bed 36 via the carrier ring interface points 256 either manually or via automated means. A method of identification can be added to the carrier ring (barcode or similar) to facilitate automatic tracking of produce.

The crop 32 can be easily released from the assembly by moving the carrier ring 236, 236′ downwards. This releases the crop holder halves 106a, 106b from the carrier ring 236, 236′ and allows the two halves 106a, 106b to separate to release the crop 32. Due to the simplicity of the actions, this process can be readily automated. The crop holder 106 and carrier ring 236, 236′ can then be cleaned and re-used.

When used in this specification and claims, the terms “comprises” and “comprising” and variations thereof mean that the specified features, steps or integers are included. The terms are not to be interpreted to exclude the presence of other features, steps or components. The singular forms “a”, “an” and “the” are intended to include the plural forms as well, unless the context clearly indicates otherwise. It will be further understood that the terms “includes” and/or “including” when used herein, specify the presence of stated features, steps, operations, elements, and/or components, but do not preclude the presence or addition of one or more other features, steps, operations, elements, components, and/or groups thereof.

The features disclosed in the foregoing description, or the following claims, or the accompanying drawings, expressed in their specific forms or in terms of a means for performing the disclosed function, or a method or process for attaining the disclosed result, as appropriate, separately, or in any combination of such features, can be utilized for realizing the invention in diverse forms thereof.

The invention is not intended to be limited to the details of the embodiments described herein, which are described by way of example only. It will be understood that features described in relation to any particular embodiment can be featured in combination with other embodiments.

It is contemplated by the inventor that various substitutions, alterations, and modifications may be made to the invention without departing from the spirit and scope of the invention as defined by the claims. Examples of these include the following:

Instead of a three-layer grow bed 36 construction, as shown in FIG. 9, the skilled person will appreciate that the grow bed 36 can also be made out of two layers so as to reduce the number of components. Milling will be required to channel a groove in one or both of the layer surfaces. Fewer layers means that thicker plastic sheets can be used in the same cross section; increasing rigidity. Milling will allow true rounded grooves to be formed, facilitating smoother and more efficient airflow through the bed. Milling will also enable two separate air routes to be implemented, allowing more uniformity of airflow distribution.

Future versions of the grow bed 36 may also utilize more interface points 228 allowing a greater overall cross-sectional area for airflow, thereby increasing efficiency.

I claim:

1. A soilless growing system, comprising:
one or more grow modules,
wherein each grow module comprises:
an enclosable volume having an interior configured to receive at least one plant in a removeable crop holder in a removable grow bed, the grow bed and crop holder configured to permit growth of the plant therethrough; and
artificial lighting configured to provide light energy to the plant,
a nutrient module configured to supply and condition an aqueous nutrient solution to the grow module; and
a HVAC module configured to supply and condition a gaseous environment to the grow module, the HVAC module configured to supply carbon dioxide into the interior of the grow module.

2. (canceled)

3. The soilless growing system, as in claim 1, wherein the grow module is formed as an elongated square bifrustum, triangular bipyramid, cuboid, rectangular cuboid, pentagonal bipyramid, hexagonal bipyramid or any suitable polyhedral shape.

4. (canceled)

5. The soilless growing system, as in claim 1,
wherein the grow module is divided into an upper volume above the grow bed which permits growth of the plant, the upper volume having an optically reflective internal is surface, and a lower volume beneath the grow bed into which the roots of the plant are periodically sprayed with the aqueous nutrient solution, the lower volume comprising a sealing liner attached to the side walls thereof, wherein the sealing liner collects and returns excess aqueous nutrient solution to the nutrient module via an outflow, and
wherein a section of the upper volume of the grow module immediately above the grow bed and which extends perpendicular to the plane of the grow bed in a vertical direction allows the grow bed to be removable by lifting it in a generally vertical direction first before moving it in a lateral plane.

6. The soilless growing system, as in claim 1, wherein the vertical height of the grow module is at least the same, or higher, than the width of the grow module in order to accommodate and permit unobstructed growth of a range of plants above the grow bed and the roots below the grow bed.

7-11. (canceled)

12. The soilless growing system, as in claim 1,
wherein the grow module is divided into an upper volume above the grow bed which permits growth of the plant, the upper volume having an optically reflective internal surface, and a lower volume beneath the grow bed into which the roots of the plant are periodically sprayed with the aqueous nutrient solution, the lower volume comprising a sealing liner attached to the side walls thereof, wherein the sealing liner collects and returns excess aqueous nutrient solution to the nutrient module via an outflow, the system further comprising:
an upper air circulation interface being situated above the grow bed, and an opposite lower air circulation interface being situated below the grow bed, the air circulation interfaces conveying the gaseous environment through the grow module and enabling circulation beneath the plant canopy and enable extraction and/or supply of airflow beneath the canopy via a perforated grow bed,
wherein the perforated grow bed being configured to allow airflow through the grow bed using channels disposed within the grow bed in fluid communication with conduits attached to the side walls of the lower volume to extract or supply air from, or to, the grow bed via the lower air circulation interface.

13. The soilless growing system, as in claim 1, further comprising:
one or more plant holders positioned in, and extending completely through, the grow bed, the plant holders configured to hold plants, wherein the roots of supported plants are exposed to the aqueous nutrient solution.

14. The soilless growing system, as in claim 13, wherein the plant holder is annular in shape having a centrally-disposed opening that extends completely therethrough, the opening being generally square-shaped in cross section from above for receiving a foam substrate configured to provide structure for plants to root into, plants rooted in the foam substrate having roots that grow downwards and extend into the lower volume of the grow module, the centrally-disposed opening having a sloped inner edge to prevent the substrate from falling through the opening when in use, the plant holder having a collar which seats inside receiving apertures disposed in the grow bed.

15. The soilless growing system, as in claim 14, wherein the foam substrate comprises a cuboid-shaped body portion having a concaved top surface and a slit running through the vertical height thereof, the concaved shape supports one or more seeds and a nutrient mixture droplet thereon, such that when the seed germinates a second foam lid is situated on top of the body portion to cover the nutrient droplet from incident light.

16. The soilless growing system, as in claim 13, wherein the plant holder is constructed of one or more pieces which, when combined, create an overall annular shape, with an outer shoulder for locating the component pieces, having a centrally-disposed opening that extends from the upper surface of the holder to a central cavity within the holder; the cavity comprising an concaved lower face, promoting liquid pooling, with a centrally-disposed concaved recess, to locate and prevent seeds from escaping from one or more radially-disposed openings that extend through the lower surface of the inner cavity, and that permit the ingress of fluid.

17. The soilless growing system, as in claim 16, wherein the plant holder is comprised of a flexible unabsorbent material that exerts a compressive force, providing a point of anchoring, on the plant stem that protrudes through the upper centrally-disposed opening and allows the plant's roots to part the lower face of the inner cavity via the one or more radially disposed-openings.

18. The soilless growing system as in claim 13, wherein the assembled plant holder is receivable in an annular carrier which seats inside a receiving aperture disposed in the grow bed, the carrier having engagement means for ease of transport and/or having a perforated elongate structure for supporting the growing plant.

19. The soilless growing system, as in claim 1, wherein the nutrient module comprises:
a nutrient reservoir in which the conductivity and pH are monitored; fresh water, nutrients and pH regulators and combinations thereof being supplied to the nutrient reservoir using dosing pumps; and
a diaphragm pump configured to pressurise an intermediary storage vessel which enables the pump to operate intermittently or periodically, such that the aqueous nutrient solution is supplied which is nutrient-rich and contributes to the growth of plants in the soilless growing system.

20-22. (canceled)

23. The soilless growing system, as claim 1, wherein the HVAC module comprises:
a fan for inducing air flow between inlet and outlet headers, an outdoor air damper/valve for controlling an inflow flow rate of fresh air introduced into a supply air duct, an exhaust damper/valve installed on an exhaust duct for discharging air from the one or more grow modules, a circulating air damper/valve installed to control the flow rate through a conditioning bypass line;
a carbon dioxide supplying device for adding carbon dioxide to the air circulated through the one or more grow modules;
a humidifying device for humidifying the air circulated through the grow module(s); and
a hot/cold water coil for heating or cooling the air circulated through the one or more grow modules.

24. (canceled)

25. The soilless growing system, as in claim 1, wherein the modules are supported in a modular racking which comprises a generally horizontal spanning member, the ends of the horizontal spanning member being receivable between pairs of vertical frame members which include a module support arm configured to support a mounting point disposed on the grow module, the modular racking being longitudinally extendable into aisles and configured to stackably support one or more other assembled racking layers above and/or below itself within the system.

26. The soilless growing system, as in claim 25, wherein the assembled racking is placed on wheeled trolleys enabling movement thereof.

27. The soilless growing system, as in claim 1, further comprising: one or more elevating devices to automatically move the grow bed between horizontally and/or vertically-spaced modules and/or to and from a processing area.

28. The soilless growing system, as in claim 1, further comprising an automated soilless growing optimiser comprising one or more computer processors having instructions written in software, wherein the instructions, when executed by the one or more processors, cause the processor to perform operations comprising:
performing a plurality of experiments for growing a plant, each experiment controlled by a recipe from a plurality of recipes that identifies parameters for growing plants;
obtaining a machine learning model by training a machine learning algorithm using the experimental results; and
creating, by the machine learning model, a new optimised recipe for growing a plant.

29. The soilless growing system, as in claim 1, further comprising an automated load-scheduling system which comprises one or more computer processors having instructions written in software, wherein the instructions, when executed by the one or more processors, cause the processor to perform operations comprising:
delay, bring-forward, shorten and/or extend scheduled automated activities of the system sub modules/units including but not limited to; photoperiods, cleaning operations, pressurisation and/or aisle movements; and
optimise the economy/efficiency of any such actions to assess the detriment to the crops and advantage of meeting a configurable/settable load/power-demand profile based upon historic data; and
thereby creating an optimised strategy for operation of the soilless growing system.

30. A method of growing plants in a soilless growing system, the method comprising the steps of:
seeding a grow bed;
germinating the seeds;
growing the plants; and
harvesting the plants, the plants being seeded, germinated, grown and harvested on the same grow bed within a soilless growing system according to claim 1.

31. The method of growing, as in claim 30, wherein the plants are grown without a substrate.
